(19) United States
(12) Patent Application Publication
(10) Pub. No.: US 2022/0170696 A1
(43) Pub. Date: Jun. 2, 2022

(54) Portable Systems, Devices and Methods for Automated Monitoring and Conditioning of Stored Agricultural Assets

(71) Applicant: Adaptive Agriculture Solutions Inc., Saskatoon (CA)

(72) Inventors: Steven Rogoschewsky, Saskatoon (CA); Dustin Maki, Saskatoon (CA)

(21) Appl. No.: 17/535,889

(22) Filed: Nov. 26, 2021

Related U.S. Application Data
(60) Provisional application No. 63/118,833, filed on Nov. 27, 2020.

(51) Int. Cl. F26B 25/22; A01F 25/22; F26B 9/06; F26B 21/10

(52) U.S. Cl. CPC F26B 25/22; A01F 25/22; F26B 2200/06; F26B 21/10; F26B 9/063

(57) ABSTRACT

A portable system for monitoring and conditioning of agricultural assets in aerated storage bins. Sensor sticks combine rigid tubing with internal sensor cables to enable penetrative submersion of sensor nodes into an existing stored volume of grain. A control unit has input terminals for connection of sensor sticks and plenum sensors, and output terminals for connection of portable construction heaters, aeration fans and headspace exhaust fans. The terminals include multi-use terminals to which different sensor and equipment types are assignable to enable a variety of different operational scenarios with different quantities of bins, heaters, fans and sensor sticks. A headspace kit includes a fan unit mountable externally to the bin near ground level, and a flexible exhaust duct routable between the fan unit and a rooftop opening of the bin for fan driven evacuation of humid air from the headspace of the bin.

### CROSS-REFERENCE TO RELATED APPLICATIONS

This application claims benefit under 35 U.S.C. 119(e) of U.S. Provisional Application No. 63/118,833, filed Nov. 27, 2020, the entirety of which is incorporated herein by reference.

### FIELD OF THE INVENTION

The present invention relates generally to systems for monitoring and actively controlling conditions of grain or other agricultural assets in storage bins, and more particularly for implementing such control at least partly through heated aeration of said storage bins.

### BACKGROUND

In the agriculture industry, it is well known to monitor the temperature and humidity levels in bins of stored grain so that adequate aeration can be ensured to prevent spoilage or infestation, and to attain customer acceptability and optimal financial compensation for the stored grain once ready for market. Conventional monitoring systems for grain storage bins employ the use of flexible sensor cables that are installed in suspended fashion from the roof of the storage bin so as to hang downward therefrom within the interior space of the bin. When the bin is subsequently filled with grain, a series of discrete sensor nodes distributed in spaced fashion along each sensor cable will reside at varying depths within the stored volume of grain. Temperature and moisture levels within the grain can thus be measured on an ongoing basis over time.

U.S. Pat. Nos. 8,806,772 and 9,347,904 disclose a particular example of a sensor cable construction, as well as a system featuring a plurality of distributed control units that cooperate to control operation of a storage bin's aeration fan, and optional heater, based on a combination of the sensor cable measurements of the grain conditions, local ambient weather conditions, specified grain type and desired equilibrium moisture content (EMC). U.S. Pat. No. 9,015,958 similarly discloses a system in which suspended sensor cables are hung inside a storage bin and used to control the aeration fan and optional heater thereof, and discloses use of the sensor cables to also control a grain spreader or discharge auger in response to identification of areas of particularly high moisture content within the grain. Operation of the spreader changes a surface profile of the grain in order to shorten an airflow path through the grain at the high moisture location, thereby increasing airflow through this location to hasten the drying thereof.

A potential shortcoming of these prior solutions is a lack of flexibility, in that the sensor cables must be pre-hung prior to filling of a grain bin, and so an already filled storage bin cannot be retrofitted to add passive monitoring or active control functionality using such prior sensor cables. Also, though the references describe optional heater control of a heated aeration setup, there is a lack of implementation detail in such regard, and no disclosure of a particularly convenient installation for adding automated heat-control functionality to a bin lacking an existing heated aeration option.

Canadian Patent 2,733,876 discloses a portable grain bin temperature probe capable of reading in-grain temperatures in a previously filled grain bin. The probe has an elongated stick-like shape formed by a series of modular sections that are assembled end-to-end via threaded connections. One end has a pointed tip for penetrating into a volume of grain from the top of a storage bin, and the other end has a wireless transmitter for communicating the temperature measurements to a remote readout device. However, the probe lacks any moisture sensors, and is operable only for measurement readout, and not for any automated control of in-bin aeration.

Accordingly, there remains a need for improved solutions for monitoring and controlling moisture and temperature conditions in stored volumes of grain or other agricultural assets.

### SUMMARY OF THE INVENTION

According to a first aspect of the invention, there is provided a portable system for monitoring and conditioning of agricultural assets held in aerated storage bins equipped with aeration fans, said system comprising:

one or more sensor sticks each comprising:
an elongated shaft that is composed of one or more shaft sections of substantially rigid tubular shape, has a hollow interior running axially through said one or more shaft sections, and has a piercing end that is penetrable into a stored volume of an agricultural asset held in an upright storage bin; and
a respective sensor cable received or receivable in said hollow interior of the elongated shaft in a position running axially therethrough, said elongated sensor cable having a plurality of sensor nodes thereon at spaced intervals therealong to measure one or more conditions outside said sensor stick at respective localized areas therealong, thus being operable to measure said one or more conditions at localized regions within said stored volume of said agricultural asset; and

a controller that:
comprises one or more input terminals from which incoming signals are receivable from at least the sensor nodes of the one or more sensor sticks to receive measurement signals therefrom that are indicative of said one or more conditions at said localized regions within said columnar volume of said agricultural asset;
comprises one or more output terminals from which control signals are transmittable from said controller to control at least operation of a portable heater that is operable to feed heated air into an aeration fan of said storage bin; and
is configured to adjust output from said one or more output terminals based at least partly on said incoming signals, and to thereby selectively control heated aeration of said agricultural asset in said storage bin.

According to a second aspect of the invention, there is provided a sensor stick for measuring conditions of agricultural assets held in upright storage bins, said sensor stick comprising:

an elongated shaft that is composed of one or more shaft sections of substantially rigid tubular shape, has a hollow interior running axially through said one or more shaft sections, and has a piercing end that is penetrable into a stored volume of an agricultural asset held in an upright storage bin; and

a respective sensor cable received or receivable in said hollow interior of the elongated shaft in a position running axially therethrough, said elongated sensor cable having a plurality of sensor nodes thereon at spaced intervals therealong to measure one or more conditions outside said sensor stick at respective localized areas therealong, thus being operable to measure said one or more conditions at localized regions within said columnar volume of said agricultural asset;

wherein the sensor stick is further characterized by at least one of the following features:

(a) said one or more shaft sections comprise a plurality of shaft sections that are configured for selective end-to-end connection to one another, and are further characterized by:
(i) accompaniment by a respective plurality of cable sections that are assemblable to form the sensor cable and are provided in equal quantity to said plurality of shaft sections, said cable sections comprising matable plugs and sockets at ends thereof for interconnection of said cable sections, whereby the sensor stick is assemblable to a user-selected length by choosing how many of the shaft sections and respective cable sections to assemble together to achieve said user-selected length; and/or
(ii) inclusion of non-threaded quick-release couplers at matable ends of said plurality of shaft sections for selective end-to-end connection of said plurality of shaft sections to one another in quick non-threaded fashion;

(b) said one or more shaft sections include a distal shaft section that defines said piercing end of the elongated shaft, and said distal shaft section is further characterized by:
(i) inclusion of helical flighting on said distal shaft section that spirals around an exterior thereof; and/or
(ii) accompaniment of said distal section by one or more shorter shaft sections that are selectively attachable to said distal shaft section at a proximal end thereof opposite the piercing end, and that are each shorter in length than said distal shaft section;

(c) inclusion of a removable handle that is selectively attachable to the elongated shaft at a proximal end thereof situated oppositely of the piercing end to provide one or more radially elongated handle grips by which to drive manual rotation of the sensor stick; and/or

(d) inclusion of a tool-engageable drive feature attached or attachable at the proximal end of the sensor stick to enable tool-driven rotation of the sensor stick.

According to a third aspect of the invention, there is provided a method for monitoring and conditioning of agricultural assets, said method comprising:

having a plurality of submerged sensor nodes residing at submerged locations in a stored volume of an agricultural asset;

performing a drying cycle, including:
(a) forcing heated air flow through said stored volume of said agricultural asset in a predetermined direction therethrough;
while forcing said heated air flow through said stored volume of grain:
(b) monitoring conditions within said stored volume of grain using said submerged sensor nodes; and
(c) also monitoring air humidity outside said stored volume of said agricultural asset at a location through which said heated air flow is exhausted from said stored volume of said agricultural asset.

According to a fourth aspect of the invention, there is provided a headspace exhaust system for use in conditioning of an agricultural asset stored within an upright storage bin, said kit comprising:

an exhaust fan unit supported or configured for supported installation in a working position nearer to ground level than to a roof level of the upright storage bin; and

a flexible exhaust duct having one end connected, or configured for connection, to an inlet of the fan unit, and an opposing end placeable into fluid communication with a headspace of the upright storage bin via an elevated opening in the upright storage bin.

### BRIEF DESCRIPTION OF THE DRAWINGS

One preferred embodiment of the invention will now be described in conjunction with the accompanying drawings in which:

FIG. 1 schematically illustrates a system for monitoring and controlling conditions in grain storage bins using grain-penetrating sensor sticks, a portable construction heater and a cooperating control unit, and more particularly illustrates use of the system in a first scenario where two storage bins are monitored, of which one is subject to automated grain drying using the portable construction heater.

FIG. 2 schematically illustrates the system of FIG. 1 in another two-bin storage scenario where a second portable construction heater is added so that both bins are subjected to automated grain drying using the same singular control unit.

FIG. 3 schematically illustrates the system of FIG. 1 in another two-bin storage scenario where the same portable construction heater and control unit responsible for automated grain drying in the first storage bin are also used to likewise perform automated grain drying in the second storage bin.

FIG. 4 schematically illustrates the system of FIG. 1 in a singular large-bin grain storage scenario where two portable construction heaters are used to cooperatively perform automated grain drying in the large storage bin through shared use of the same singular control unit.

FIG. 5 schematically illustrates the system of FIG. 1 in a variant of the same two bin scenario, but using the singular control unit to not only automate operation of the portable construction heater, but also automate operation of the bin's aeration fan.

FIG. 6 illustrates the control unit of the system of FIGS. 1 through 5 with associated cable components through which incoming measurement signals and outgoing control signals are received and transmitted by the control unit.

FIG. 7 is a schematic circuit diagram illustrating how the control unit is interfaced via one of said cable components with a heating control circuit of the portable construction heater to enable the automated control thereof.

FIG. 8 is a schematic block diagram illustrating use of the system in connection with a communication network to enable user notifications, remote user monitoring, and data collection and reporting functionality.

FIG. 9 illustrates one of the sensor sticks in a fully unassembled state.

FIG. 10 is an exploded view of the sensor stick of FIG. 9 in a partially pre-assembled state with sensor cable sections installed in respective shaft sections to form modular components selectively assemblable with one another to form a sensor stick of varying length.

FIGS. 11A through 11C show the sensor stick of Figures and 10 in final assembled states of varying length.

FIG. 12 is a partial cross-sectional view of one of the cable-equipped shaft sections of FIG. 10, and shows a front elevational view of a sensor node of one of the sensor cable sections in its pre-installed position inside its respective shaft section.

FIG. 13A is an exploded view of the sensor node of FIG. 12 in a fully disassembled state.

FIG. 13B is a partially assembled view of the sensor node of FIG. 13A.

FIG. 13C is a fully assembled side elevational view of the sensor node of FIG. 12.

FIG. 13D is a cross-sectional view of the fully assembled sensor node of FIG. 13C, as viewed along line D-D thereof.

FIG. 14 schematically illustrates use of the system of FIG. 1 in combination with a novel exhaust fan kit in a singular storage bin scenario, in which the added exhaust fan is operable to evacuate humid air from a headspace of the storage bin.

FIG. 15 is a bottom perspective view of a fan unit of the exhaust fan kit of FIG. 14.

FIG. 16 is a top perspective view of the fan unit of FIG. 15.

FIG. 17 is a top plan view of the fan unit of FIG. 15, illustrating mounted support thereof on an access ladder of the storage bin.

### DETAILED DESCRIPTION

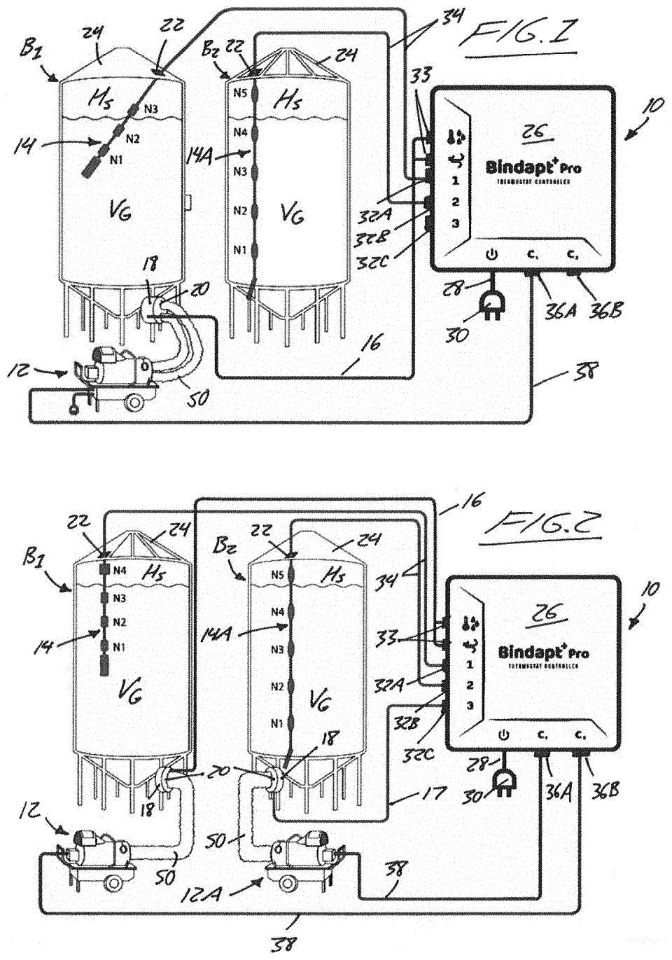

FIGS. 1 through 5 illustrate a variety of grain drying scenarios achievable using a novel portable system of the present invention that's operable to monitor grain conditions in one or more grain storage bins B₁, B₂, and to perform automated control of a heated aeration process for drying out the stored volume of grain V_{G} inside in least one of those storage bins B₁, B₂. In brief, the system is composed of a main control unit 10, one or more portable construction heaters 12, 12A, and at least one sensor stick 14, 14A that is penetrable into a columnar volume of stored grain V_{G} in an already-filled storage bin in order to measure one or more conditions, typically at least temperature and moisture, within that stored volume V_{G} of grain. Preferably one or more plenum sensor cables 16, 17 are also included for the purpose of measuring conditions in an air plenum 18 of the storage bin that's pressurized by the storage bin's existing aeration fan 20, which in a known manner is operable to drive an upward flow of air through the stored volume of grain V_{G} for the purpose of controlling temperature and moisture levels within the grain.

The portable construction heater 12, when operated, feeds heated air into the air intake of the aeration fan 20, whereby the air blown into the plenum 18 and distributed upwardly through the stored volume of grain V_{G} is pre-heated by the portable construction heater 12, whereby this heated airflow hastens the drying of excess moisture from the grain compared to use of the fan alone without an accompanying heater. The main control unit 10 receives measurement signals from the sensor sticks 14 that are indicative of the temperature and moisture conditions in the grain, and preferably also receives measurement signals on the conditions inside the plenum 18, and uses these signals to derive measurement data that is then used to control operation of the portable construction heater to automate drying of the grain to a desired equilibrium moisture content (EMC).

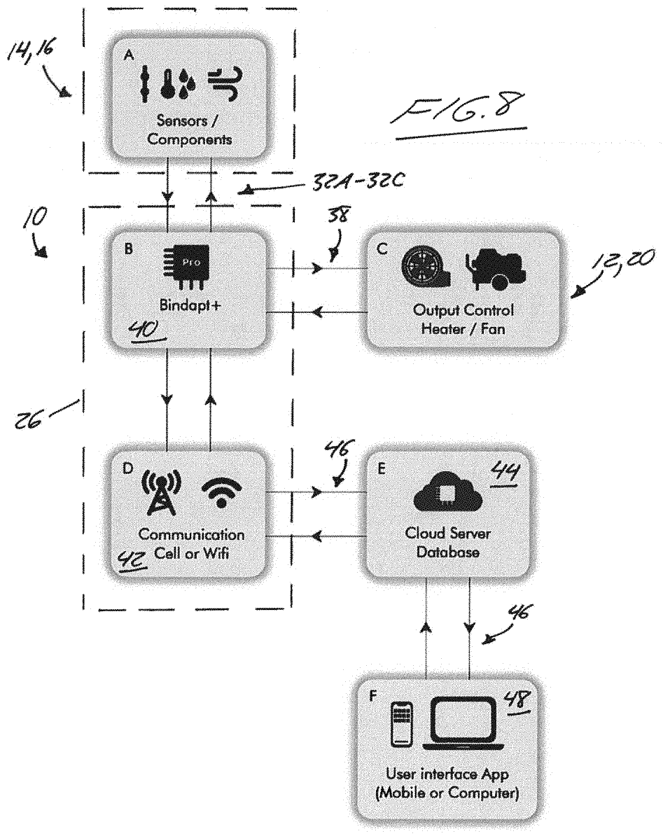

The sensor sticks 14 are illustrated only schematically in FIGS. 1 through 5, though novel construction details of the sensor sticks 14 are described in more detail further below with reference to FIGS. 9 through 13. Referring to the schematic illustrations of FIGS. 1 through 5 for now, each sensor stick has a plurality of sensor nodes N₁-N₅ installed in series at discretely spaced intervals along an axial length of the sensor stick. Each sensor stick 14 is penetrated downwardly into a stored volume of grain V_{G} in one of the storage bins B₁, B₂ through an opening 22 in a roof 24 the storage bin. As a result, at least some of the sensor nodes N₁-N₅ are submerged within the stored volume grain V_{G} and reside at respective elevational locations within the storage bin, i.e. at respective depths from the upper surface of the stored volume of grain V_{G}. These submerged sensor nodes are thus operable to measured conditions of the grain at different localized regions therein of varying depth or elevation to one another to provide the master unit with a measurement data set reflective of conditions throughout the stored volume of grain V_{G}.

In at least one preferred embodiment, at least one sensor of each sensor stick (e.g. N₃ of the sensor stick in storage bin B₁, and N₅ of the sensor stick in storage bin B₂) is left in an unsubmerged position outside the stored volume of grain V_{G} in an air-filled headspace H_{S} left open between the roof 24 of the storage bin and the upper surface of the stored volume of grain V_{G}. The exposed sensor node N₃, N₅ in the headspace H_{S} of each storage bin can be used to measure moisture content in the air of the headspace H_{S}, which during a drying cycle forcing heated air upwardly through the storage volume of grain can serve as an indicator of the relative completion of the drying cycle, as described in further detail below.

The main control unit 10 comprises a housing 26 in which various electronic components of the main control unit 10 are internally contained. An exterior of the housing 26 features a power cord 28 by which the electronic components are connectable to a suitable source of electrical power via a terminal power plug 30 at a distal end of the cable, a plurality of quick-connect input terminals 32A-32C to which selective connection can be made of one or more sensor sticks 14 using compatible extension cables 34, and to which a secondary plenum sensor cable 17 can also optionally be selectively connected in interchangeable fashion for one of said sensor sticks 14. Since these particular input terminals are capable of use for either grain measurement or plenum measurement purposes, and can accordingly receive selective connection of grain measuring or plenum measuring equipment in interchangeable fashion, they are referred to herein as multi-purpose input terminals. In the illustrated embodiment, there are three such multi-purpose input terminals 32A-32C, whereby one can choose to optionally connect anywhere from one to three sensor sticks 14, and in the event that less than three sensor sticks 14 are connected, can choose to optionally connect the secondary plenum sensor cable 17 at one of the available input terminals unoccupied by the extension cable(s) of the less than full set of connected sensor stick(s) 14.

In addition to the multi-purpose input terminals 32A-32C to which sensor sticks and the secondary plenum cable 17 are selectively connectable and disconnectable, the illustrated example of the control unit 10 also features a dedicated dual-input terminal 33 to which a primary plenum sensor cable 16 is permanently attached in non-detachable fashion. The primary plenum sensor cable 16 is a bundled combination cable composed of a signal cable 16A having internal conductors for two-way communication of electrical signals therethrough, and a tubular air hose 16B through which air from the storage bin plenum is communicable to an onboard pressure sensor contained in the housing 26 of the main control unit 10. With reference to FIG. 6, a terminal cable head of the primary plenum cable 16 has a mounting body 16C for securing at a hole in a boundary wall of the plenum, a sensing probe 16D protruding axially from the mounting body to place an internal temperature sensor and humidity sensor of this probe inside the plenum of the storage bin when the mounting body 16A is secured thereto, and a terminal hose section 16E of the air hose 16B that likewise protrudes axially from the mounting body 16C to reach into the plenum of the storage bin. Instead of a signal cable and a separate external air hose bunded thereto, it may be possible to integrate an air conduit and the signal cable into a singular compound cable in which they share a common outer cable jacket.

The dedicated dual-input terminal 33 of the main control unit has a signal wire terminal to which the signal cable of the bundled primary plenum sensor cable 16 is wired for receiving electrical measurement signals specifically from the temperature and humidity sensors in the probe 16B of the terminal cable head, and also a hose terminal for receiving an air sample from the plenum through the air hose to enable local determination of the air pressure in the plenum by the control unit's onboard pressure sensor. By comparison, the secondary plenum sensor cable 17 is a singular signal cable 17 having only the temperature and humidity sensor probe on its terminal cable head, and is therefore incapable of measuring plenum pressure, but has the advantage of being interchangeable for a sensor stick extension cable 34 at any of the three multi-purpose input ports 32A-32C. The secondary plenum sensor cable 17, the signal cable of the bundled primary plenum sensor cable 16, and the sensor stick extension cables 34 are preferably all embodied by simple two-wire signal cables capable of two way communication between the main control unit 10 and the sensor-carrying PCBs in the plenum cable probes and the sensor stick nodes. The exterior of the control unit's housing 26 in the illustrated example also includes a plurality of output terminals 36A, 36B by which one or more portable construction heaters 12A, 12B, or other equipment to be controlled, can be selectively connected or disconnected via respective control cables 38, whose details are outlined herein further below.

In a variant of the main control unit 10 and the primary plenum sensor cable 16, instead of having the pressure sensor disposed locally within the main control unit 10 on a common circuit board shared by some or all of the other electronic components of the main control unit 10, and instead of relying on a lengthy air hose to communicate this local on-board sensor of the main control unit with the plenum, the pressure sensor may be provided remotely of the main control unit 10 on a separate dedicated circuit board at the terminal cable head, from which a much shorter air hose would protrude into the plenum of the storage bin to fluidly communicate the interior plenum space with the pressure sensor. The circuit board of the pressure sensor and the circuit board of the temperature and humidity probe could thus share the same signal cable to communicate with the main control unit, without needing an accompanying air hose or integrated air conduit running back to the main control unit. In another variant, the pressure sensor, temperature sensor and humidity sensor of the terminal cable head could be situated on a shared singular circuit board wired to the signal cable.

Referring to FIG. 8, inside the housing 26, the electronic components of the main control unit 10 include a processing unit 40 having a processor, non-transitory computer readable memory coupled to the processor and having stored thereon statements and instructions executable by processor to perform a variety of routines, including any and all actions described herein and attributable to the main control unit 10. The electronic components preferably also include a wireless transceiver 42 operable to wirelessly communicate with a remote server 44 (e.g. cloud server) via the internet or other wide area network 46, and/or communicate with a user device 48, such as a smartphone, tablet computer, desktop computer, etc. The user device is operable to present a software user interface to a user for any one or more of a variety of purpose, including viewing current and/or historical conditions in the one or more storage bins being monitored; viewing a current operational status of the system; performing remote real-time control of system components, such as activating or deactivating the heater(s); and making on the fly changes to operational parameters used by the system in its automated control routines.

The same user interface is preferably also used for the purpose of initial configuration setup of the system by user-input of various initial setup parameters (grain type, desired ECM, headspace humidity threshold, etc.). Communication with the user-device 48 may be over a local area network, but more preferably is indirect communication over the wide area network using the remote server 40 as an intermediary to enable data exchange between the control unit 10 and the user device 48. Use of a separate user-device 48 to perform the initial configuration setup of the system enables optional omission of an on-board display and user-inputs on the main control unit 10 itself, whereby such omission of a local user-interface on the main control unit 10 reduces the component count and complexity of the control unit, and the associated cost thereof. However, it will be understood that the main control unit 10 in other embodiments may include an on-board user interface for initial setup configuration and on-site readout of measurement data, operating status, etc.

FIG. 1 shows a first exemplary use of the system, where two storage bins B₁, B₂ both store a respective columnar volume of grain V_{G}, each of which is monitored for temperature and moisture conditions at various localized regions therein by a respective sensor stick 14, 14A, each of which is connected to a respective input terminal 32A, 32B of the main control unit to transmit temperature and moisture measurement signals thereto. Using a respective control cable 38, one of the output terminals 36A of the main control unit 10 is connected to a singular portable construction heater 12, whose one or more hot air outlets feed into the air intake of the aeration fan 20 of a first one of the storage bins B₁, for example via flexible ducting 50. The connection of the ducting to the aeration fan 20 may be achieved using Applicant's patented adapter, disclosed in U.S. Pat. No. 10,709,145, the entirety of which is incorporated herein by reference, whereby a dual-outlet portable construction heater can optionally have both hot air outlets thereof connected to the same aeration fan 20, as shown. In the FIG. 1 scenario, only the primary plenum sensor cable 16 is used, and specifically has its sensor head 16A operably installed at the first storage bin B₁ to measure plenum temperature, humidity and pressure of this first bin. In the drawing, the sensor head 16A is installed at the part of the plenum defined by the duct that feeds into the bin B₁ from the aeration fan 20.

In the FIG. 1 scenario, only the first bin B₁ is operable to perform heated grain drying on an automated basis through control of the singular portable construction heater 12 by the main control unit 10. Such control is based at least partly on the grain measurement data derived from readings of the sensor nodes N₁-N₃ of the first sensor stick 14, and preferably is also based in part on the plenum measurement data derived from readings of the primary sensor cable's sensor head 16A. The second bin B₁ has no portable construction heater connected thereto to enable such heated aeration, but the second sensor stick 14A penetrated into the stored grain of the second storage bin B₂ is nonetheless connected to an input terminal 32B of the main control unit 10 to at least enable remote monitoring of the grain conditions inside the second bin via the user interface of the remote user device 48.

In the FIG. 1 scenario, the only piece of equipment controlled by the main control unit 10 is the singular portable construction heater 12 used to automate heated grain drying in the first bin B₁, and so the second output terminal 36B is unused. In this instance, a secondary plenum sensor cable 17 is not used to measure plenum conditions in the second storage bin B₂, since automated drying or aeration control is not being performed on that second bin. In the illustrated scenario, where only two sensor sticks 14, 14A are connected to the control unit 10, one for each storage bin, input terminal 32C is therefore unused due to the lack of need for the secondary plenum measurement cable 17. However, it will be appreciated that this available input terminal 32C may alternatively be used to connect a third sensor stick, for example to be used together with the first sensor stick 14 in the heated first bin B₁ to provide greater grain measurement resolution inside that first bin B₁.

FIG. 2 illustrates another two-bin grain storage setup that, like FIG. 1, has two storage bins B₁, B₂ whose respective columnar volumes of stored grain are again respectively monitored by first and second sensor sticks 14, 14A that are penetrated into the grain to a partially submerged level leaving an uppermost sensor node of each sensor stick in an exposed position outside the grain in the air-filled headspace H_{S} of the storage bin. However, in the FIG. 2 scenario a second portable construction heater 12A is added, whereby both output terminals 36A, 36B of the main control unit 10 are now each connected to a respective portable construction heater for automated control thereof via a respective control cable 38. The second heater's one or more hot air outlets feed into the air intake of the aeration fan 20 of the second storage bin B₂, again preferably via flexible ducting 50 and optionally using Applicant's patented adapter.

In the Figure scenario 2, the primary plenum sensor cable 16 is again used on the first storage bin B₁, but this time is accompanied by a secondary plenum sensor cable 17 that is connected to one of the input terminals 32C and is routed to the plenum 18 of the second storage bin B₂. This enables measurement of the plenum temperature and humidity of the second bin for cooperative use thereof in combination with the grain temperature and grain moisture measurements from the second sensor stick 14A to automate the heated aeration of the grain in the second bin B₂. And thereby perform automated grain drying therein. With each bin B₁, B₂ in this scenario having its own respective set of stick-carried grain sensor nodes, its own respective plenum sensor cable and its own respective heater, the main control unit 10 shared by the two bins is operable to run in a multi-bin multi-heater mode that performs independently automated drying of grain in the two bins, regardless of whether the bins contain the same or different types of grain, and/or whether the initial grain moisture levels in those two bins are the same or different.

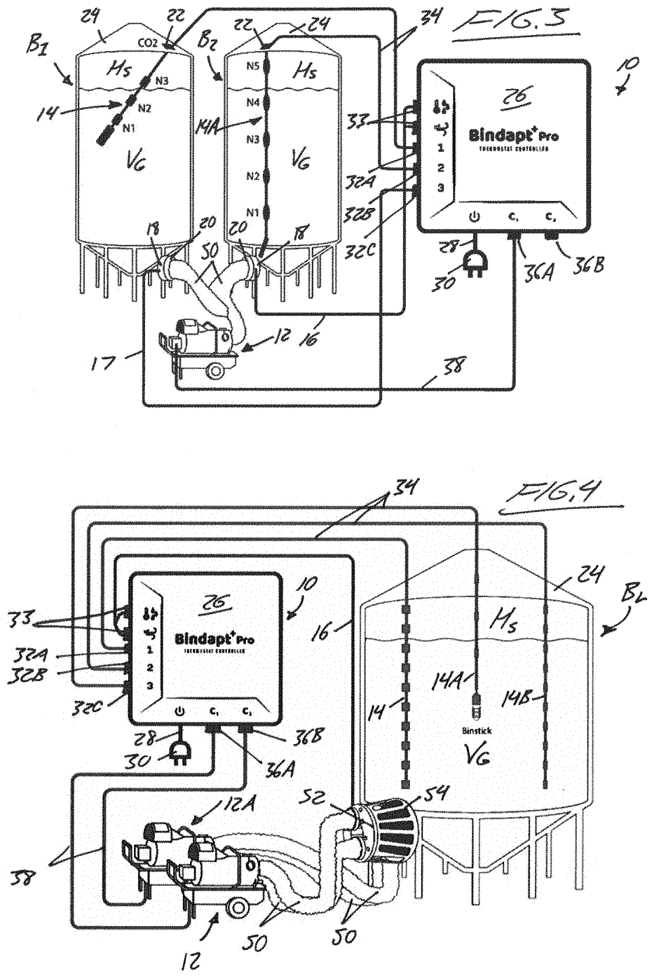

FIG. 3 illustrates yet another two-bin grain storage setup that, like FIGS. 1 and 2, has two storage bins B₁, B₂ whose respective stored volumes of grain are again respectively monitored by first and second sensor sticks 14, 14A that are penetrated into the grain to a partially submerged level leaving an uppermost sensor node of each sensor stick in an exposed position outside the grain in the air-filled headspace H_{S} of the storage bin. However, in the FIG. 3 scenario, only a singular portable construction heater 12 is used, like in FIG. 1, yet both storage bins B₁, B₂ are heated in automated fashion under the control of the main control unit 10. To enable this, a dual-outlet portable construction heater 12 is used, of which each of its two hot air outlets is connected the air intake of the aeration fan 20 of a respective one of the two aerated storage bins B₁, B₂, via a respective flexible duct 50. Only one of the two output terminals 36A, 36B is used in this scenario, in this case being connected to the singular heater 12 via a respective control cable 38. Like in FIG. 2, both of the primary and second plenum sensor cables 16, 17 are used to monitor the plenum conditions of both bins, whereby all three multi-purpose input terminals 32A-32C are again used by a combination of the two sensor sticks 14, 14A and the secondary plenum cable 17. With each bin B₁, B₂ having its own respective set of stick-carried grain sensor nodes and its own respective plenum sensor cable, the main control unit 10 shared by the two bins is operable to perform automated drying of grain in the two bins, though not in the fully independent fashion contemplated in FIG. 2 due to the shared reliance of the two bins on the same heater 12.

When the main control unit runs in a multi-bin shared-heater drying mode in such scenarios as FIG. 3 where multiple storage bins are heated by the same heater, the control unit may be configured to terminate operation of the heater once the moisture level in the grain of one bin has been reduced to the desired EMC, as detected by the respective sensor stick in that bin, even if the moisture level in the other bin is still measuring above the desired EMC by more than acceptable threshold. Using this approach, potential over-drying in the “finished bin” is safely avoided. The main control unit 10 may be configured to notify one or more responsible personnel via their user device(s) 48 of this “partially finished” status of the multi-bin shared-heater drying cycle, so that appropriate action can be taken to enable further drying in the other bin whose drying process is incomplete (the “unfinished” bin). On receiving such notification, the alerted party can visit the multi-bin storage site, disconnect the heater from the finished bin, and then re-initialize operation of the control unit via the user interface, but this time under a single-bin drying mode to continue drying the grain in the unfinished bin until the desired EMC is achieved therein. As with the FIG. 1 scenario, where only one storage bin is being heated for grain drying purposes, this single-bin drying mode may, in addition to running a single-bin dryer control routine on the one bin, may be a multi-purpose operating mode in which an “unheated monitoring” routine is simultaneously performed on the other bin of the multi-bin storage site.

Though not specifically shown, it will also be appreciated that the system can of course also be operated in a purely single-bin operating mode for a single-bin single-heater storage setup that, except for the omission of the second bin B₂ and second sensor stick 14A, is the same as pictured in FIG. 1. FIG. 4 illustrates another example of a single bin storage setup making use of the inventive system, but in this case using multiple heaters 12, 12A to heat a large singular storage bin B_{L}. Here, where the large diameter of the bin introduces the potential for greater temperature and/or moisture variation within the larger volume of grain, a plurality of sensor sticks 14, 14A, 14B are all used within the same bin B_{L} as one another, and are respectively connected to different input terminals 32A-32C of the main control unit 10. The two heaters 12, 12A both have their heated air outlets connected to the air intake of the singular bin's aeration fan 20 via flexible ducts 50 and an adapter.

In the illustrated example, each heater 12, 12A is a dual-outlet heater, and the adapter has not only a connection adapter 52 of the same type described in Applicant's aforementioned US patent, but also a supplemental adapter 54. This supplemental adapter 54 has an output end thereof fitted over the air intake of the bin's aeration fan, and an axially opposing inlet end thereof at which the connection adapter 52 is mounted to the supplemental adapter. Two of the four flexible ducts 50 from the two heaters 12, 12A connect to the connection adapter 52 to feed air axially into the supplemental adapter 54, and onwardly therethrough into the aligned air intake of the aeration fan. The remaining two flexible ducts 50 connect directly to the supplemental adapter 54 to feed heated air radially thereinto to mix with the other stream of heated air being blown axially through the supplemental adapter 54 from the connection adapter 52 into the air intake of the aeration fan. The two heaters 12, 12A are respectively connected to the two output terminals 36A, 36B of the main control unit 10 via respective control cables 38, through which control signals are transmitted by the control unit 10 to the two heaters to control operation thereof based on detected grain and plenum conditions inside the large storage bin B_{L}. Such control is performed in substantially the same manner as for the other scenarios of FIGS. 1 through 3, but makes use of greater sensor resolution in the larger volume of storage grain V_{G} due to the inclusion of multiple sensor sticks penetrating into that same volume of grain.

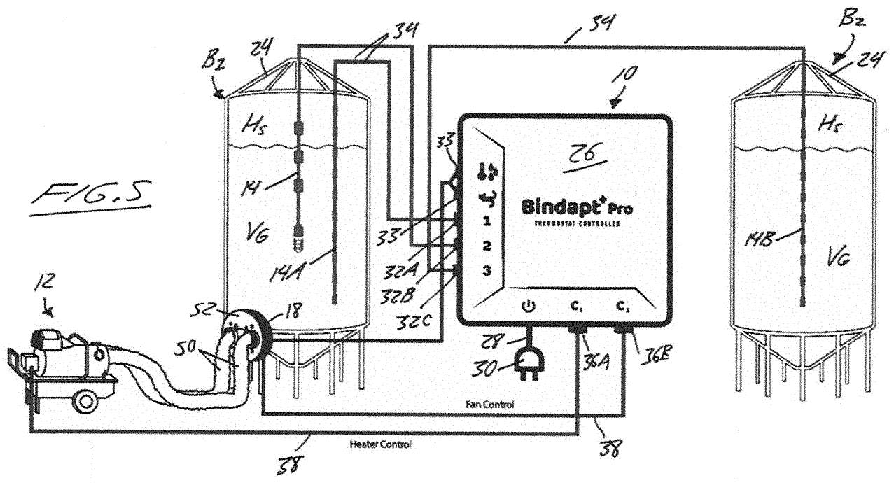

FIG. 5 shows another two-bin grain storage setup that is substantially the same as that shown in FIG. 1, but differs at least in that the second output terminal 36B is used to connect the master control unit 10 to the aeration fan 20 of the first bin B₁, whereby the master control unit 10 can control both the portable construction heater 12 and the aeration fan 20, which in the illustrated example is hidden from sight behind the illustrated connection adapter 52. FIG. 5 also illustrates how, like in FIG. 4, more than one sensor stick 14, 14A can optionally be used in the heated storage bin B₁, regardless of the size thereof. The illustrated example shows two sensor sticks 14, 14A in the heated first storage bin B₁ that is used for grain drying, and one sensor stick 14C in the second unheated storage bin that's used for non-heated storage, yet has its grain contents monitored by the control unit. So though the second bin is not subjected to heated grain drying, the system is still useful, for example to trigger alarm notifications to the user device(s) of one or more responsible personnel should excessively high temperatures or moisture conditions signify problematic conditions in the second bin that require preventative measure before full spoilage occurs.

As with FIG. 1, this non-heated second storage bin B₂ can be used as a buffer for holding grain that's awaiting subsequent drying in the heated first storage bin B₁, where once the current batch of grain in the heated first storage bin is dried and subsequent unloaded from the bin, the buffered batch of grain in the second storage bin B₂ can be transferred into the first bin B₁ for drying therein. Alternatively, if the second storage bin is an aerated bin with an aeration fan, once the drying process in the first bin B₁ is completed, the portable heater can be disconnected from the aeration fan of the first bin, and connected to the aeration fan of the second bin to dry the grain therein in automated fashion, optionally using the same sensor stick 14C already in place in the second bin.

To enable significant flexibility by which this and other various adaptations of the system can be performed to suit a variety of different storage/drying scenarios, the user interface includes toggles or other tools by which the user can assign the different input terminals 32A-32C & 33 and the different output terminals 36A, 36B to different bin identifiers (Bin IDs) representative of the different storage bins, and can likewise assign different input types (sensor stick vs. plenum cable) to the multi-purpose input terminals 32A-32C, and assign different equipment types (heater vs. fan) to the output terminals 36A, 36B. The main control unit accordingly adapts its algorithmic control routines in terms of which input terminal's incoming measurement signals should be used to make various control decisions, and in terms of which of the output terminals the outgoing control signals should be sent to control whatever external equipment is connected thereto.

So in the FIG. 5 example, the user sets the Bin ID to “Bin 1” for input terminals 32A, 32B & 33 and to “Bin 2” for input terminal 32C; sets the input type for all three multi-purpose input terminals 32A-32C to “sensor stick”; sets the Bin ID to “Bin 1” for both of the output terminals 36A & 36B; sets the equipment type to “heater” for output terminal 36A and to “fan” for output terminal 36B. The user inputs a desired EMC and the grain type for at least the first bin B₁, and the control unit runs in a multi-purpose mode running a “single bin single heater” drying routine for bin B₁ that automates operation of the heater 12 to dry to the grain therein, while also running a “bin monitoring” routine for bin B₂ that monitors and logs (e.g. in a database of remote server) grain measurements from bin B₂ for selective viewing of current and historical data of that bin's contents in the user interface of the user device(s). In addition to logging grain measurements, the “bin monitoring” routine on bin B₂ is also operable to initialize transmission of alarm notifications (e.g. via remote server) to the user device(s) should problematic conditions be detected in bin B₂. Likewise, the drying routine running for bin B₁ also includes such data logging and notification functions. Optionally, the user may also input the grain type and desired EMC for bin B₂, whereby if detected achievement of the desired EMC for bin B₂ occurs, notification to the user device(s) is likewise triggered to notify the responsible person(s). User setup and resulting operation of the control unit for the FIG. 1 scenario would be similar to that described for FIG. 5, except that input terminal 32C and output terminal 36B would be left unassigned, and input terminal 32B would be assigned to “Bin 2” rather than “Bin 1”.

For the FIG. 2 scenario, input terminals 32A, 32B & 33 are assigned the same Bin IDs and input types as for FIG. 1, but input terminal 32C would be assigned with a “Bin 2” Bin ID and “plenum cable” input type, while each output terminal 36A, 36B would both be set with “heater” as the equipment type, and each assigned a different respective one either “Bin 1” or “Bin 2” as its Bin ID. For the FIG. 3 scenario, the setup would be similar to that described for FIG. 2, except that output terminal 36B is left unassigned. As can be seen from comparison of FIGS. 2 and 3, the particular bins to which the plenum sensor cables 16, 17 are run from input terminals 32C and 33 may optionally be reversed, provided that the Bin IDs are properly assigned to those input terminals. Finally, for the FIG. 4 scenario, the user sets the Bin ID to “Bin 1” for all input terminals 32A-32C & 33; sets the input type for all three multi-purpose input terminals 32A-32C to “sensor stick”; and sets the Bin ID and equipment type to “Bin 1” and “heater” for both of the output terminals 36A & 36B.

The main control unit 10 can trigger transmission of “drying complete” signals to the remote device(s) to signify achieved completion of a drying cycle on the grain in one or more bins once detection has been made that the grain has reached the desired EMC based on the measurement data from the submerged sensor nodes of the sensor stick(s) 14. The main control unit 10 can also make use of the exposed sensor node(s) of the sensor stick(s) 14 in the headspace(s) H_{S} of the bin(s) to transmit “anticipated completion” signals to the remote devices that signify in advance that the drying cycle is nearly complete. The control unit does this by monitoring the air moisture data derived from the exposed sensor node(s) at the top of the sensor stick(s) 14 in the headspace(s) H_{S} of the storage bin(s) throughout the drying cycle. While the heater(s) and aeration fan(s) start up at the beginning of a drying cycle, the initially high moisture content of the grain will mean that the exhaustive flow of air that escapes the top surface of the stored grain and vents outwardly to the outside environment through the headspace H_{S} of the bin will have a dramatically high level of humidity as it carries out the excess moisture from the wet grain. The control unit 10 monitors this air humidity in the headspace(s) H_{S} of the storage bin(s), and once a significantly notable (and thus reliably detectable) drop in the humidity of the headspace H_{S} is detected, this signifies that less moisture is now being carried off by the exhaustive airflow, signifying a notable reduction in the grain's moisture content from its original level. This detected drop in headspace air humidity thus triggers transmission of the “anticipated completion” signal to the user device(s), so that the responsible person(s) are pre-warned of impending completion of the drying cycle. This way, the person(s) can plan ahead for necessary actions, such as an on-site visit to take a physical sample and confirm the desired drying results, or making scheduled arrangements for offloading of the grain from the bin, and transport thereof to its intended customer.

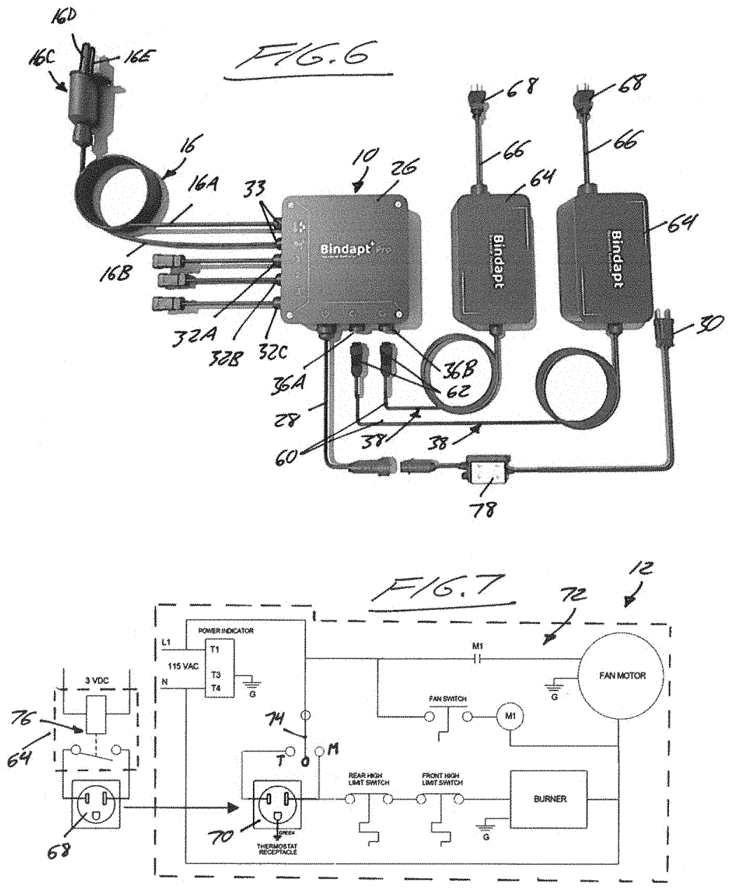

In FIG. 6, two control cables 38 for connecting the two output terminals 36A, 36B of the main control unit 10 to respective portable constructions heaters are shown. Each control cable 38 is composed of a proximal cable section 60 having a connector 62 attached at one end thereof for selective mating with either output terminal 36A, 36B of the main control unit 10, a control box 64 at an opposing end of the proximal cable section 60, and a distal cable section 66 extending from the control box 64 and terminating in a male plug 68 by which connection is made with to a compatible female electrical socket 70 on the respective portable construction heater. This plugged connection establishes functional electrical connection between the main control unit 10 and the heater control circuitry 72 of the portable construction heater, an example of which is shown in FIG. 7. At least some models of commercially available portable construction heaters include such a female electrical socket 70, which is normally used for the purpose of enabling optional connection of a remote thermostat to the portable construction heater, and thus is also referred to herein as a thermostat connection socket.

Referring to FIG. 7, the heater control circuitry includes a toggle selector switch 74 movable between “manual”, “off” and “thermostat” positions marked as M, O and T in the circuit diagram. The off position O denotes an open break between a burner circuit and voltage source of the heater's control circuitry to turn the heater off, while the manual position M establishes a direct closed connection between the burner circuit and the voltage source in order to operate the burner, i.e. turn on the heater. The thermostat position T indirectly connects the voltage source to the burner circuit via the thermostat connection socket 70, so that a remote thermostat optionally plugged into the thermostat connection socket can selectively make and break the connection across the socket 66 to selectively activate and deactivate the burner, thus switching the heater on and off. The control box 64 of each control cable 38 contains a normally open relay 76 whose primary side is connected to one of the main control unit's output terminals 36A, 36B via the proximal cable section 60 and attached connector 62. Accordingly, a low voltage command signal is sent from an output terminal when the processor executed dryer routines call for heat based on the measured grain and plenum conditions, which causes the secondary side of the relay 76 to close. The secondary side of the relay is wired to the male plug 68 of the control cable 78 via the conductors of the distal cable section 66, whereby via the thermostat connection socket 70, this closure of the secondary side of the relay 76 connects the burner circuit of the heater 12 to its voltage source, thereby turning on the heater 12.

The overall system described above is extremely portable, and easy to move from one bin or storage location to another with quick and easy setup. The main control unit's power cord 28 is simply connected to a suitable power source, whether directly to a compatible low voltage (e.g. 12V) DC power source, or to a mains AC power outlet via a suitable AC/DC adapter 78 (shown in FIG. 6). The primary plenum sensor cable 16 is run to a plenum of a storage bin in which heated aeration is to be automated for grain drying purposes. Here the sensor head 16A is fastened in a position protruding into the plenum 18 through a hole provided or cut in a boundary wall thereof to place the plenum sensors inside the plenum. One or more sensor sticks 14 are penetrated into a stored volume of grain already in the bin, or alternatively could be hung from the roof of a bin into which grain is yet to be added, and are connected to the main control unit 10 via flexible extension cables 34. A portable heater 12 is placed near the aeration fan of the storage bin concerned, and preferably physically connected thereto by flexible ducting 50, and a control cable 38 is then plugged into the heater's thermostat connection socket 70 at one end, and connected to an output terminal 36A, 36B of the main control unit at the other end. A fully operational grain drying system is thereby quickly and easily established, transforming a non-heated storage bin into an automated grain dryer. Via optional connection of multiple sensor sticks and a secondary plenum sensor cable to the multi-purpose input terminals, and/or optional connection of another heater or fan controller via the second output terminal, a large variety of different single-bin or multi-bin grain drying/monitoring scenarios are easily achievable, as illustrated by the non-limiting examples of FIGS. 1 through 5.

Having provided a thorough overview of the system and its operation, portability and flexibility, attention is now turned to FIGS. 9 through 13 to describe a novel bin stick construction of the present invention, which may be employed for any or all of the sensor sticks briefly described above and schematically illustrated in the earlier figures. FIG. 9 illustrates components of one non-limiting example of a modular sensor stick construction of the present invention. The sensor stick is assembled from two primary subassemblies: a hollow but rigid exterior shaft that enables penetration of the sensor stick 14 into an existing stored volume of grain, and a flexible internal sensor cable that runs axially through a hollow interior of the exterior shaft to support the plurality of sensor nodes therein in an electronically communicable fashion with the main control unit. Both the shaft and the cable are of modular construction to enable assembly of sensor sticks of varying length to best suit various grain storage scenarios of variable bin size.

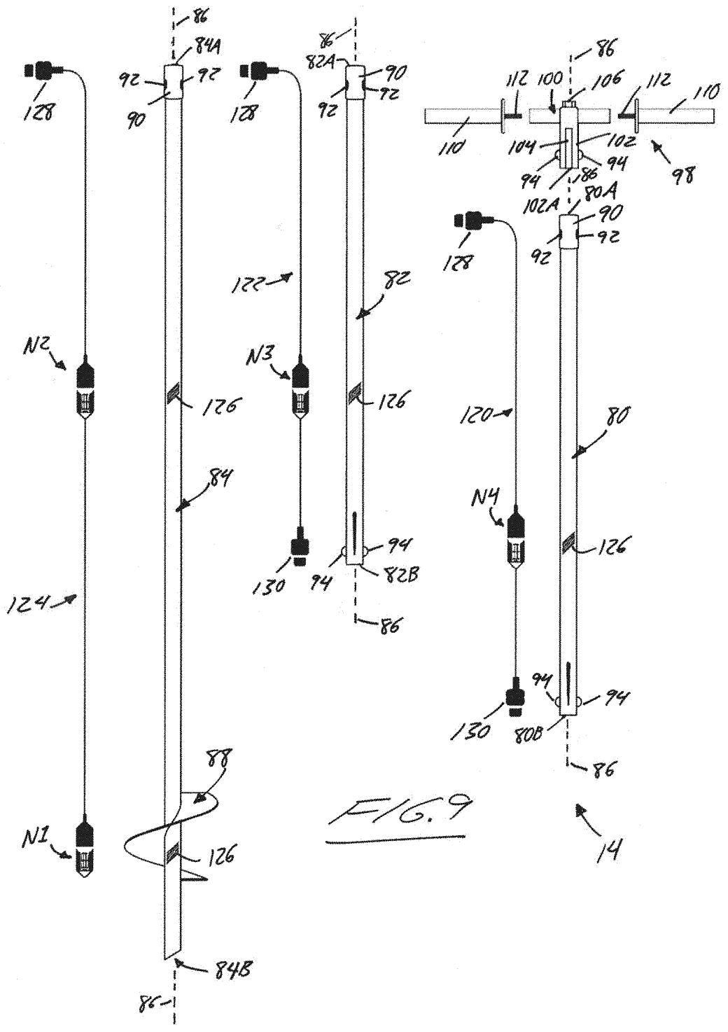

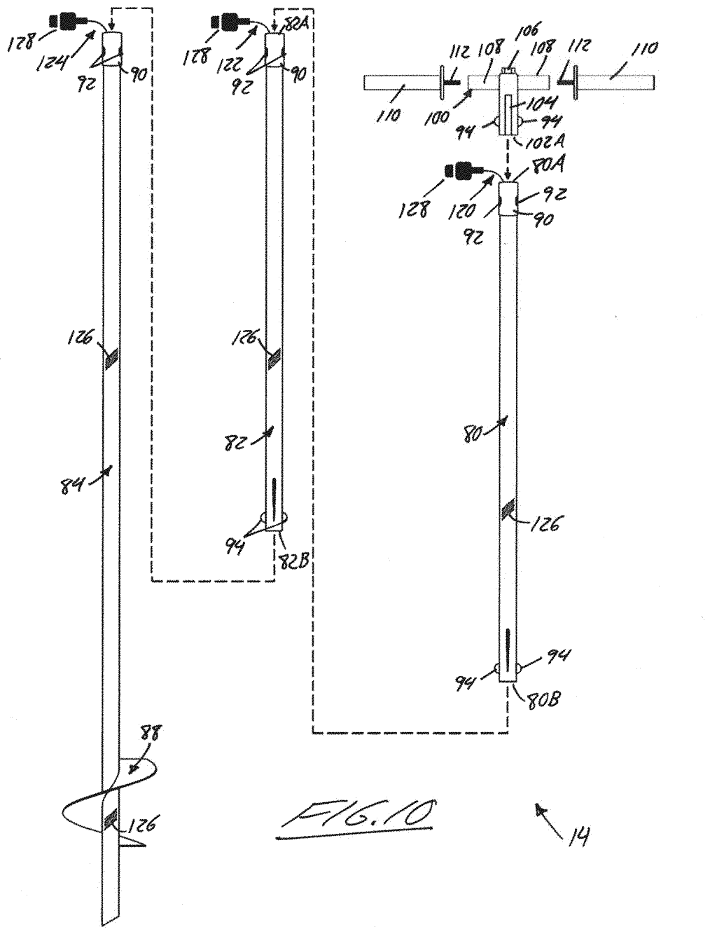

In the illustrated example, the shaft is composed of three shaft sections, though the same modular construction principles may be applied to a sensor stick with as few as two sections, or with more than three section. With reference to their relative positions in the assembled state of the shaft, the three illustrated shaft sections are referred to herein as a proximal shaft section 80, an intermediate shaft section 82 and a distal shaft section 84. Each shaft section comprises a length of hollow metal tubing of linear form and rigid self-sustaining shape, namely a substantially cylindrical tube whose circular cross-section is centered on a respective central longitudinal axis 86. Measured along their respective longitudinal axes 86, the axial lengths of the proximal and intermediate shaft sections 80, 82 are equal to one another, while the distal shaft section 84 has greater axial length exceeding those of the other shaft sections. The distal shaft section 84 is a primary essential component of the modular shaft that is always used as part of the assembled sensor stick 14, regardless of the desired overall user-selectable length of the assembled sensor stick 14. One or both of the other two shaft sections 80, 82 are optionally assembled end-to-end with the distal shaft section 84 in colinear series therewith, as shown in FIGS. 11A and 11B, if the desired shaft length of a needed sensor stick exceeds the axial length of the distal shaft section 84 alone.

The distal shaft section 84 has a proximal end 84A at which either of the other shaft sections 80, 82 can be selectively coupled, and an opposing distal end 84B that defines a terminal piercing end of the sensor stick when assembled. As shown, this distal piercing end 84B can optionally be cut obliquely to the shaft section's longitudinal axis 86 to give this end a pointed or tapered shape for more effective penetration into the top surface of the stored grain volume V_{G} in a storage bin. To help drive the assembled sensor stick 14 further down into the stored grain volume V_{G}, the distal shaft section 84 includes helical flighting 88 that spirals around an exterior of the shaft section's hollow tubular shaft body over, at least over a partial fraction of the shaft section's axial length. In the illustrated example, this helical flighting 88 spans only a relatively small minority of the shaft section's axial length, for example making two or fewer full turns therearound at a location nearer to the distal end 84B of the distal shaft section 84 than to the proximal end 84A thereof. Accordingly, the helical flighting 88 will be engage with the grain soon after initial penetration of the upper surface thereof by the piercing end 84B of the sensor stick, whereafter manual or tool drive rotation of the assembled sensor stick in a predetermined direction around longitudinal axis 86 will help drive the sensor stick downwardly through the grain. Meanwhile, the relatively small axial span of the helical flighting in the illustrate embodiment minimizes the overall weight added to the distal shaft section 84 by the inclusion of such flighting, so as not to overly detriment handling and portability of the sensor stick.

A localized and enlarged proximal area 90 of the tubular shaft body of the distal shaft section 84 includes the proximal end 84A thereof, and is of slightly greater internal and external diameter than the remaining uniform-diameter majority of the tubular shaft body that spans from this enlarged proximal area 90 down to the piercing distal end 84B of the shaft section. The other two shaft sections 80, 82, at proximal ends 80A, 82A thereof, both likewise have an identically configured proximal area 90 of enlarged interior and exterior diameter relative to the remaining uniform-diameter majority of the shaft section's tubular shaft body. The enlarged proximal area 90 of each shaft section imparts a female configuration to the proximal end of the section, whereby the proximal end of each shaft section is capable of receiving insertion of the smaller diameter distal end of one or more like-configured shaft sections to enable end-to-end assembly of the shaft sections, to thereby form an assembled sensor stick. The proximal and distal ends of the shaft sections are thus also referred to herein female and male ends, respectively.

The enlarged proximal areas 90 each feature a pair of diametrically opposed catch holes 92 therein, while distal areas of the proximal and intermediate shaft sections 80, 82 residing adjacent to the distal ends thereof each feature a matching pair of diametrically opposed detents 94. These detents 94 are spring biased into locking positions protruding radially outward from the exterior of the tubular shaft body. Such spring bias may be provided, for example, by a U-shaped spring band that carries the detents thereon and resides inside the tubular shaft body, and pushes the two detent outwardly through a pair of diametrically opposed holes in the wall of the tubular shaft body. Accordingly, when the male end 80B, 82B of the proximal or intermediate shaft section 80, 82 is inserted into the female end 82A, 84A of the intermediate or distal shaft section 82, 84, the spring loaded detents 94 are temporarily deflected inward as the male end one of shaft section is inserted into the female end of the other, until the detents 94 reach aligned positions with the catch holes 92, whereupon the spring loaded detents 94 pop back outwardly into their default locking positions. In these positions, the detents now engage through the two aligned catch holes 92 thereby automatically locking the two shaft sections together in a non-threaded snap-fit fashion. This forms a quick-release connection, subsequent release of which, in order to unlock and decouple the two shaft sections from one another to disassemble the sensor stick, requires only a simple one-handed depression of the two detents 94 in an inwardly pinched fashion between a thumb and finger of a user, whereupon the locking action between the two shaft sections is released, enabling them to be pulled axially apart.

In addition to the shaft sections, the illustrated modular sensor stick 14 features a multi-piece handle assembly 98 composed of a hub 100 and two grip extensions 110. The hub 100 is configured to enable selective coupling thereof to the female end of any of the three shaft sections 80, 82, 84, while the two grip extensions 110 are each selectively connectable to the hub on a respective one of two opposing sides thereof. The hub has a T-shaped structure with an upright stem 102 formed of a short length of metal tubing of equal diameter to the uniform-majority length of each shaft section, whereby a distal lower end 102A of this stem 102 has the same male configuration as the distal ends 80B, 82B of the proximal and intermediate shaft sections 80, 82. This enables the insertion of the stem's male distal end 102A into the female proximal end 80A, 82A, 84A of any shaft section to place the stem 102 of the handle 98 in end-to-end colinear relationship with that shaft section. The stem 102 also features a pair of spring loaded detents 94 of the same type found on the distal areas of the proximal and intermediate shaft sections 80, 82 to enable the same type of snap-fit quick release connection between the handle assembly and the proximal end of any of the shaft sections. The stem 102 also has a cable accommodation slot 104 that extends axially therealong in an upward direction from the distal end 102A thereof. The slot 104 is long enough such that, after assembly of the handle 98 to a selected shaft section, a proximal end of the slot remains outside that shaft section at a location situated outwardly beyond the proximal end thereof.

A nut 106 or other tool-engageable drive feature is affixed to the proximal end of the stem 102 so as to reside at a top of the handle 98 for operational tool driven rotation of the assembled sensor stick 14 about the central longitudinal axis 86 that is shared by the assembled shaft section(s) and handle stem 102. The hand hub 100 features two handle arms 108 that project radially outward from the stem 102 adjacent the proximal end thereof, and that reside in parallel relation to one another at opposing sides of the stem 102 so as to collectively lie diametrically thereof. The two grip extensions 110 are each selectively connectable to a respective one of the handle arms 108 at an outer end thereof furthest from the central stem 102 of the hub 100. Such selective connection of the two grip extensions may be achieved, for example, by rotational mating of a threaded male stud 112 of each grip extension 110 with a threaded female socket inside the respective handle arm 108. When the grip extensions are coupled to the hub 100, they notably increase the radial measure of the assembled handle 98 dramatically beyond the outer diameters of the assembled shaft sections. This enables a user to respectively grasp the two grip extensions 110 with two hands, and apply notable rotational torque to the assembled sensor stick 14 about it's longitudinal axis 86 to drive the auger-like advancement of the sensor stick 14 into the stored volume of grain thanks to the included helical flighting 88. As an alternative to manual rotation of the sensor stick, a powered socket tool can be engaged with the drive nut 106 at the top of the handle 98 in order to drive the rotation of the sensor stick in tool-powered fashion, in which case the optional grip extensions 110 need not be attached.

Referring to FIG. 9, the internal sensor cable is composed of a number of cable sections of equal quantity and proportionally similar respective length to the shaft sections. Accordingly, the illustrated example is therefore a three-section modular cable featuring a proximal cable section 120 of similar but slightly greater length to the proximal shaft section 80, an intermediate cable section 122 of equal length to the proximal cable section 120 and similar but slightly greater length to the intermediate shaft section 82, and a distal cable section 124 of similar but optionally shorter length than the distal shaft section 84, and greater length than both of the proximal and intermediate cable sections. The longer distal cable section 124 has a greater quantity of sensor nodes than each of the shorter cable sections 120, 122. In the illustrated example, the distal cable section 124 has two sensor nodes N1, N2, while each of the shorter cable sections has only one respective sensor node N3, N4. Each cable section is installed inside the respective shaft section so that the cable section runs axially through the hollow interior of the shaft section's tubular shaft body. The tubular shaft body of each shaft section, at each location internally occupied by a respective one of the sensor nodes N1-N4, has a set of small openings 126 in the tubular wall of the shaft section to enable airflow between the shaft exterior and hollow shaft interior via these openings 126. The openings 126 may be narrow slits as shown in the drawings, but may alternatively have other shapes. These openings 126 may be appropriately sized to prevent grain from entering the hollow interior of the shaft.

A proximal end of each cable section has a proximal cable connector 128. A distal end of each of the proximal and intermediate cable sections 120, 122 has a respective distal cable connector 130 that is selectively matable with any of the proximal cable connectors 128. These cable connectors 128, 130 thus enable interconnection of one or both of the proximal and intermediate cable sections 120, 122 end-to-end in series with the distal cable section 124 to enable conductive signal communication through the interconnected cable sections. Since the distal cable section would be the last cable section in any assembled string of cable sections, it lacks a distal connector 130, and instead terminates at a lowermost sensor node N1 of the assembled sensor cable.

The proximal and intermediate cable sections 120, 122 are each slightly longer than their respective shaft sections 80, 82, such that in the installed positions of these cable sections 120, 122 within the hollow interiors of their respective shaft sections 80, 82, at least one of the cable section's two ends can reach outwardly beyond the respective end of the shaft section, thereby placing at least one of the two cable connectors 128, 130 of the cable section outside the respective shaft section. This external placement of the cable connector enables connection to the corresponding matable cable connector found on either the next sensor cable section, or on the storage-bin end of the extension cable 34 by which the assembled sensor stick 14 is to be connected to the main control unit 10. For example, FIG. 10 shows the cable sections 120, 122, 124 installed in their respective shaft sections 80, 82, 84, and the proximal cable connector 128 of each cable section 120, 122, 124 can be seen to reside externally of the respective shaft section near the proximal end 80A, 82A, 84A thereof. This way, the proximal cable connector 128 of the distal cable section 124 can be plugged into the distal cable connector 130 of the intermediate cable section 122 inside the distal end 82B of the intermediate shaft section 82, before the male distal end 82B of the intermediate shaft section 82 is then inserted into the female proximal end 84A of the distal shaft section 84. During such mating of the intermediate and distal shaft sections 82, 84, the extra slack in the distal cable section 124 is tucked down into the proximal female end 84A of the distal shaft section 84. The same cable and subsequent shaft coupling procedure is likewise performed at the interface between the proximal and intermediate cable and shaft sections, in instances where all sections are assembled to maximize the overall sensor stick length.

Still referring to FIG. 10, when the handle hub 100 or full handle assembly 98 is installed on the proximal shaft section, the slot 104 in the stem 102 of the handle hub 100 accommodates the hanging of the proximal end of the proximal cable section 120 out of the proximal female end 80A of the proximal shaft section 80 during the insertion of the handle stem 102 into same. The same cable accommodation by the slot 104 of the handle stem occurs regardless of which of the shaft sections the handle 98 is selectively installed on to achieve the desired one-section, two-section or three-section length of the assembled sensor stick. Accordingly, illustrated by FIGS. 11A through 11C, the proximal cable connector 128 of the respective cable section of the shaft section onto which the handle assembly 98 is installed hangs outside the sensor stick near the handle-equipped top end thereof regardless of the assembled section quantity and resulting stick length. Accordingly, this uppermost proximal cable connector is connectable to the extension cable 34 that is routed to the main control unit 10 to enable two-way communication thereof with the assembled sensor stick. Such connection of the extension cable 34 is performed after the assembled bin stick has been rotationally augered into the stored grain of a storage bin, thus preventing cable twisting during the rotational driving of the auger-flighted sensor stick.

While the illustrated example of the sensor stick embodiment has three sections, the number of intermediate sections may be increased to attain an even greater stick length than the three-section sensor stick shown in FIG. 11A, for example to accommodate particularly tall storage bins capable of holding a larger volume of grain whose greater depth is not sufficiently penetrable with a three-section sensor stick. Also, while the illustrated example of the snap-together shaft sections that are interconnectable via simple insertion of male shaft ends into enlarged female shaft ends has the proximal ends being of female configuration and the distal ends being of male configuration, this arrangement may alternatively be reversed. Also, while the illustrated embodiment describes optional tool driven rotation of the assembled sensor stick into the grain via a hub component 100 of a multi-piece handle assembly 98, it will be appreciated that the selectively insertable tool-driven component need not necessarily be part of a handle that has includes radially extending grips 110 for optionally manual rotation. Furthermore, where a manually operable handle is provided in selectively attachable fashion to any section of the modular sensor stick, it need not necessarily be a multi-piece handle assembly from which the radially extending hand grips 110 are selectively attachable and detachable for optimally compact storage and transport.

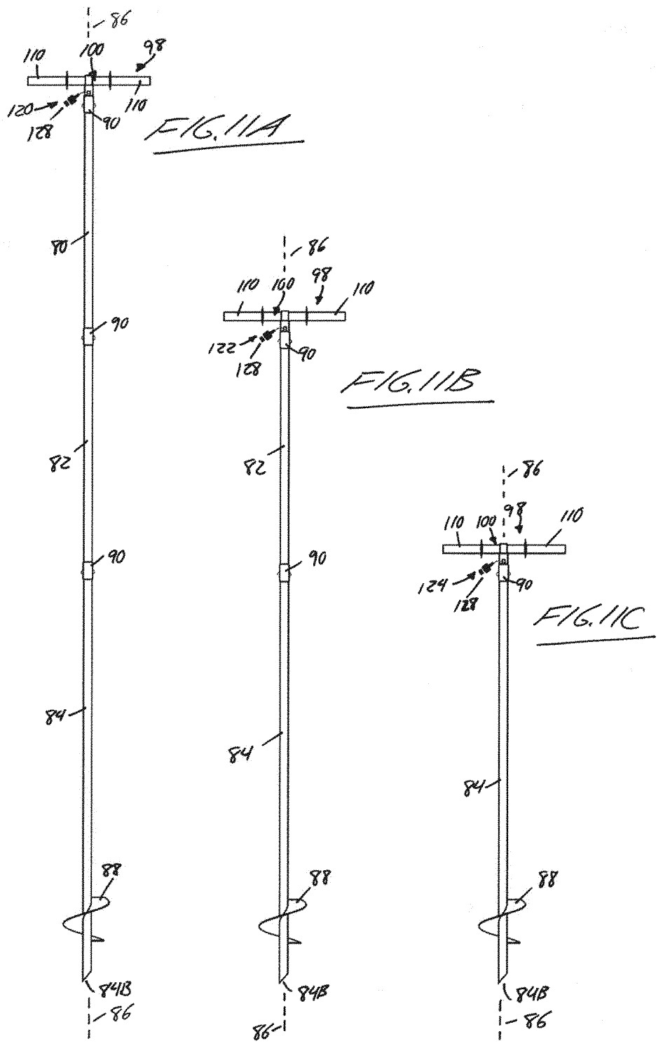

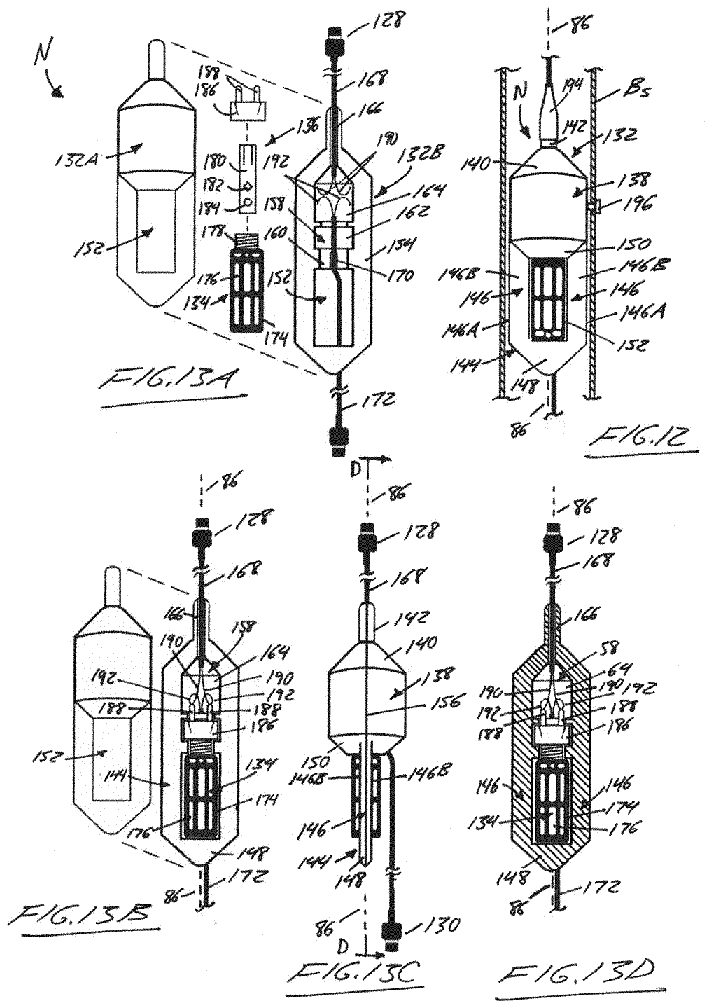

FIGS. 12 and 13 illustrate in more detail the assembled structure and individual componentry of one of the node sensors. In the illustrated embodiment, the nodes sensors are all of substantially identical to construction to one another, and so any description given of the particular exemplary node N in FIGS. 12 and 13 can likewise be applied to every other node of the sensor stick shown in FIGS. 9 through 11, except where noted otherwise. The illustrated node N features a sensor housing 132, a sensor cover 134 supported thereon, and a sensing unit 136 also supported by the sensor housing and shielded in protective fashion by the sensor cover 134. The sensor housing 132 is composed of two matable shell-like housing components 132A, 132B, which are mated and fastened together during assembly of the sensor node. FIGS. 12 and 13C show the sensor node N in its fully assembled state, with FIG. 12 also showing the assembled sensor node N in its installed condition inside a respective one of the shaft sections of the sensor stick. The tubular shaft body of that shaft section is labelled generically as B_{S} and is shown vertically sectioned along the shaft section's central longitudinal axis 86 in a plane lying diametrically thereof.

In its assembled state, the two-piece sensor housing 132 has a main body 138 of externally cylindrical form whose outer diameter is equal to, or only slightly less than, an internal diameter of the shaft section's tubular shaft body B_{S}, as best seen in FIG. 12. This way, when the sensor housing 132 is inserted into the hollow interior of the tubular shaft body B_{S}, the sensor housing 132 is automatically placed, and retained, in a generically coaxial relationship to the tubular shaft body. The cylindrical main body 138 of the sensor housing 132 and the cylindrical wall of the tubular shaft body B_{S} thus share the same central longitudinal axis 86 of the shaft section. At the top end of the housing sensor's main body 138 is an upwardly tapered transition shoulder 140 that joins the main body 138 to a terminal upper neck 142 of the sensor housing 132. This upper neck 142 is of notably lesser than the maximum outer diameter of the sensor housing at the cylindrically exterior main body 138. Affixed to the bottom end of the cylindrical main body 138 is a frame body 144, which is composed of two stiles 146 extending downwardly from the main body 138 at diametrically opposing sides thereof, and a sill 148 that horizontally interconnects the two stiles 146 at bottom ends thereof furthest from the main body 138.

In a width measurement that is measured perpendicularly transverse of the central longitudinal axis 86 in one direction, an outer width of the frame body 144 is measured from an outer edge 146A of one stile 146 to the outer edge 146A of the other stile 146, and is equal to the outer width (i.e. outer diameter) of the cylindrical main body 138. The two stiles 146 therefore run parallel to diametrically opposing sides of the shaft section's tubular shaft body B_{S} in respectively close adjacency thereto, as shown in a front view of the sensor in FIG. 12. On the other hand, in a thickness measurement that is measured perpendicularly transverse of both the central longitudinal axis 86 and the width measurement, a thickness of the frame body 144 measured between two opposing outer faces 146B of either stile 146 is much less than the outer width (i.e. outer diameter) of the cylindrical main body 138. The frame body 144 is therefore much thinner and flatter and the main body 138, as seen in a side view of the sensor in FIG. 13C. Accordingly, significant air space is left open inside the tubular shaft body B_{S} on opposing front and rear sides of the sensor housing's frame body 144, whereas the main body 138 of the sensor housing spans a substantial entirety of the radial measure of the shaft body's interior space.

As shown in the front view of FIG. 12, the top ends of the two stiles 146 are joined together in the width direction by a downwardly tapered transition shoulder 150 at the bottom end of the main body 138. Below the main body 138, the frame body 144 thus delimits a rectangular window space 152 between the stiles 146, the sill 148 and the downwardly tapered transition shoulder 150. In the fully assembled state of the sensor node N, the sensors thereof reside within this window space 152, as described in more detail below, and are protected by the frame body 144 from potential impact prior to, and during, insertion of the sensor node into one of the shaft sections 80, 82, 84 during installation of the cable sections 120, 122, 124 into the shaft sections 80, 82, 84.

Referring to the exploded views of FIGS. 13A and 13B, the two housing components 132A, 132B of the sensor housing 132 are identical or substantially similar to one another. Each housing component 132A, 132B has a flat inner side 154 of planar form for flush mating against the matching flat inner side of the other housing component. An opposing outer side of each housing component has a profiled shape that embodies a respectively semi-cylindrical half 138B of the cylindrical exterior of the assembled housing's main body 138, and also embodies one of the two outer faces 1466 of each of the two stiles 146 of the frame body 144. When the flat inner sides of the two housing components 132A, 1326 are placed together, the interface of these flat inner sides denotes a plane of symmetry of the resulting overall shape of the assembled sensor housing 132. This plane of symmetry contains, and lies diametrically of, the central longitudinal axis 86 in the width direction of the sensor housing. This plane of symmetry at the meeting of the inner faces of the two housing components 132A, 132B is represented by visible seam 156 in FIG. 13C. In the assembled state of the sensor node, the two housing components 132A, 132B are attached together, for example by a suitable bonding agent applied to the mated inner faces, and/or by included screw fasteners, or integrally incorporated snap-fit coupling elements optionally integrated into the housing components.

The sensor housing 132 includes an internal cavity 158 that spans axially upward from the window space 152 into the main body 138. A respective half of the cavity is recessed into each of the two symmetrically configured housing components 132A, 1326 from the flat inner face 154 thereof. Starting at the window space 152 and moving axially upward therefrom, the cavity includes a cover-holding chamber 160 situated nearest to the window space 152, a connector-holding chamber 162 situated adjacent to the cover-holding chamber, and a wiring chamber 164 situated adjacent to the cover-holding chamber 162 on the side thereof opposite the cover-holding chamber 160. An upper wiring bore 166 penetrates axially through the neck 142 of the sensor housing into the wiring chamber 164 of the internal cavity 158. This wiring bore 166 accommodates routing of an upper connector cable 168 into the wiring chamber 164 of the internal cavity 158 of the sensor housing 132. A lower wiring slot 170 opens through the lower transition shoulder 150 of the sensor housing into the cover-holding chamber 160 of the internal cavity 158 to accommodate routing of a lower connector cable 172 into the internal cavity 152, and upwardly therethrough into the wiring chamber 164 thereof.

In the case of any of the sensor nodes N2-N4 shown in FIG. 9, and in any other case of the solo or uppermost sensor node in any given shaft section of the sensor stick, the upper connector cable 168 is the part of the cable section that spans from the sensor node to the proximal cable connector 128 of that cable section. In the case of sensor nodes N3 and N4, or in any other case of a solo or lowermost sensor node of a cable section other than the distal cable section, the lower connector cable 172 is the part of the cable section that spans from the sensor node to the distal cable connector 130 of that cable section. In the case of sensor node N2 in FIG. 9, or in any other case of an uppermost or other non-lowermost sensor node of a multi-node cable section, the lower connector cable 168 is the part of the cable section that spans from this sensor node to a downwardly neighbouring sensor node situated further down the cable section. In such instance, this lower connector 168 also serves as the lower connector cable of that downwardly neighbouring sensor node sensor node on the same cable section.

Similarly, the case of sensor node N1 in FIG. 9, or in any other case of a lowermost or other non-uppermost sensor node of a multi-node cable section, the upper connector cable 168 is the part of the cable section that spans from this sensor node to an upwardly neighbouring sensor node situated further up the same cable section, and therefore also serves as the lower connector cable of that upwardly neighbouring sensor node. This can be seen in FIG. 9, where the connector cable spanning between nodes N1 & N2 of the multi-node distal cable section 124 can be interpreted as both the upper connector cable 168 of sensor node N1 and the lower connector cable 172 of sensor node N2. This particular connector cable thus forms a direct permanent connection between these two neighbouring nodes N1, N2, unlike the releasable plug-based connection made between nodes of different cable sections via the selectively matable and releaseable cable connectors 128, 130. In the case of sensor N1, i.e. the lowermost sensor node of the overall sensor cable that resides deepest within the grain in the sensor stick's grain-penetrating working position, no lower connector cable 172 is included at this node since there is no downwardly neighbouring node nor a distal cable connector 130.

The sensor cover 134 has a structural cage 174 of generally cylindrical form whose skeletal framework leaves openings therein on all sides thereof for admission of air into the sensor cover. The cage 174 is lined with a porous mesh filter 176 that spans each of these openings to prevent dust or other contaminant particulate from entering the cover 134. As shown, the combination of the skeletal cage 174 and the mesh filter 176 attributed a lantern-like appearance to the sensor cover of the illustrated embodiment. The mesh filter 176 spans both the bottom end and radially outer circumference of the cage 174, but does not span the top end thereof, which is instead left open to accommodate insertion therethrough of a printed circuit board (PCB) 180 of the sensing unit 136 during assembly of the sensor node. This opening at the top end of the cage 174 is surrounded by a cylindrical mounting rim 178 that is received in the cover-mounting chamber 160 of the sensor housing's internal cavity 158, and that is captured therein when the two housing components 132A, 132B are mated and secured together. The PCB 180 features both a temperature sensor 182 and a humidity sensor 184 installed thereon, and is mated with a wiring connector 186 through which the conductor wires of the upper and lower connection cables 168, 172 are electrically connected to the PCB 180 to communicate with the sensors thereon. The wiring connector 186 is received in the connector-holding chamber 162 of the housing's internal cavity 158, and is captured therein when the two housing components 132A, 132B are mated and secured together.

Wiring terminals 188 of the wiring connector protrude into, or are at least accessible from, the adjacent wiring chamber 164 of the sensor housing's internal cavity 158. The insulated portions of the connector cables 168, 172 reach into the wiring chamber 164, where the two conductor wires 190 of the upper connector cable 168 and the two conductor wires 192 of the lower connector cable 172 are bared. The bared conductor wires 190, 192 are soldered, crimped or otherwise conductively attached to the two wiring terminals 188 of the wiring connector 186. As a result, the PCB 180 of the sensing unit is wired in parallel with those of the other sensor nodes of the same sensing cable to enable addressed communication of the main control unit 10 with all of the sensor nodes of that sensor cable. The main control unit 10 is thus operable to receive temperature measurement signals and humidity/moisture measurement signals from the temperature and humidity sensors 182, 184 of each sensor node, to thereby garner measured grain temperature data and grain moisture data from all submerged sensor nodes in a volume of stored grain, and optionally to also garner headspace air temperature and humidity data using the temperature and humidity signals from an exposed uppermost sensor node in the headspace H_{S} of the storage bin if left unsubmerged for such purpose.

The uppermost sensor node may employ the same sensors as the other sensor nodes, and rely on different calibration thereof in the software of the main control unit to account for it's measurement of air conditions rather than grain conditions. In such instance, the user interface may include a toggle or other selector tool for assigning the uppermost node of each sensor stick either a “submerged” or “exposed” status identifier according to whether the storage bin is filled to a level in which the uppermost node is submerged within the stored grain volume, or left exposed outside the grain in an empty (i.e. air-filled, not grain-filled) headspace of the storage bin. Such a submerged/exposed status identifier may also be assignable to additional nodes further down the cable, with the optional exception of the lowermost node N1 that would always be expected to have a submerged status except in an entirety-empty storage bin scenario, whereby the system can accommodate a wide variety of storage bin fill levels, an in each case distinguish between grain and headspace measurement data. In other embodiments, a discrete headspace sensor unit separate from the sensor sticks may be employed for the headspace measurements, in which case the sensor nodes may optionally be toggled with an on/off status identifier instead of a submerged/exposed status identifier, where the software uses the currently toggled status to determine whether to query or record signals from that sensor node at all, rather than to decide whether to classify the signals therefrom as grain measurement signals or air measurement signals.

To assemble the sensor node, the connector cables 168 and 172 are laid into or routed through their respective wire routing passages (e.g. wiring bore 166, wiring slot 170) into positions reaching into the wiring chamber 164, where their conductor wires 190, 192 are stripped, if not already bare, and soldered or otherwise electrically coupled to the wiring terminals 188 of the wiring connector 186, if not already pre-attached thereto. The PCB 180 is secured to the wiring connector 186, if not already pre-attached thereto, to project axially therefrom at the underside thereof opposite the wiring terminals 188. The open end of the sensor cover 134 is slid over the sensor-carrying portion of the PCB 180 that protrudes from the wiring connector 186, until the mounting rim 178 of the sensor cover 134 abuts the underside of the wiring connector 186, whereby the PCB 180 and the sensors 182, 184 thereon are now fully enclosed within the filter-protected interior of the sensor cover 134. The wiring connector 186 and the mounting rim 178 of the sensor cover 134 are laid down into the holding chamber halves of one of the two housing components 132B, which as shown in FIG. 13B, places the cage 174 of the sensor cover 134 into the respective half of the window space delimited by the frame body 144 of that housing component 132B. The two housing components 132A, 132B are then mated and secured together at their flat inner sides 154, thus capturing the wiring connector 186 and the mounting rim 178 of the sensor cover 134 within their respective holding chambers 162, 160 of the housing's internal cavity 158, while the sensor-carrying PCB 180 resides within the open window space 152. Here, the PCB 180 and the sensors 182, 184 thereon are exposed to surrounding air outside the sensor housing 132, yet are protected from impact by the stiles 146 and sill 148 of the frame body 144, and are shielded from dust or other particulate contaminants by the mesh filter 176 carried by the cage 174 of the sensor cover 134. With reference to FIG. 12, after assembly of the sensor housing 132 to capture the other components in the internal cavity 158 thereof, heat shrink tubing 194 is preferably applied around the upper neck 142 of the sensor housing 132 and the upper connector cable 168 that emerges therefrom to ensure a fully sealed closure of the upper wiring bore 166 and internal cavity 158 of the housing. This prevents penetration of contaminants thereinto that could detriment the wiring and electrical components contained within in the internal cavity 158.

The cable sections 120, 122, 124 are preferably pre-installed in the respective shaft sections 80, 82, 84 by the manufacturer, whereby the end-user only needs to plug together the cable connectors 128, 130 and mate the selected shaft sections 80, 82, 84 and the handle 98 together to achieve a ready-to use sensor stick 14. During such pre-installation of the cable sections in the shaft sections, once each sensor node is advanced through the shaft section interior into a properly aligned position with the respective set of openings 126 in the tubular shaft body of the shaft section, the sensor node is preferably secured in this position to maintain proper alignment with the openings 126. With reference to FIG. 12, such securement can be effected by way of one or more screw fasteners 196 driven through the wall of the tubular shaft body B_{S} and into the relatively thick peripheral wall of the cylindrical main body 138 of the sensor housing 132. Through use of sufficiently short fasteners 196, penetration thereof into the internal cavity 158 of the sensor housing is avoided to prevent potential damage to the wiring or electronic componentry therein. The sensor housing 132 is preferably positioned so that the diametric plane occupied by the stiles 146 of the frame body 144 of the sensor housing 132 is of non-intersecting relation to the openings 126 in the wall of the tubular shaft body B_{S}, whereby the stiles don't obstruct any part of these openings. This helps ensure adequate air communicably between the filter-protected sensors 184, 186 and the exterior of the sensor stick's shaft structure is achieved to ensure accurate measurement of the grain or air temperature surrounding the shaft at the respective axial location of the sensor node in question. So, with reference to FIG. 12 for example, the opening 126 in the tubular shaft body B_{S} preferably reside in front of the illustrated sensor node N in the cut-away front half of the tubular shaft body, and/or behind the illustrated sensor node N in the rear half of the tubular shaft body B_{S} hidden behind the illustrated sensor node N.

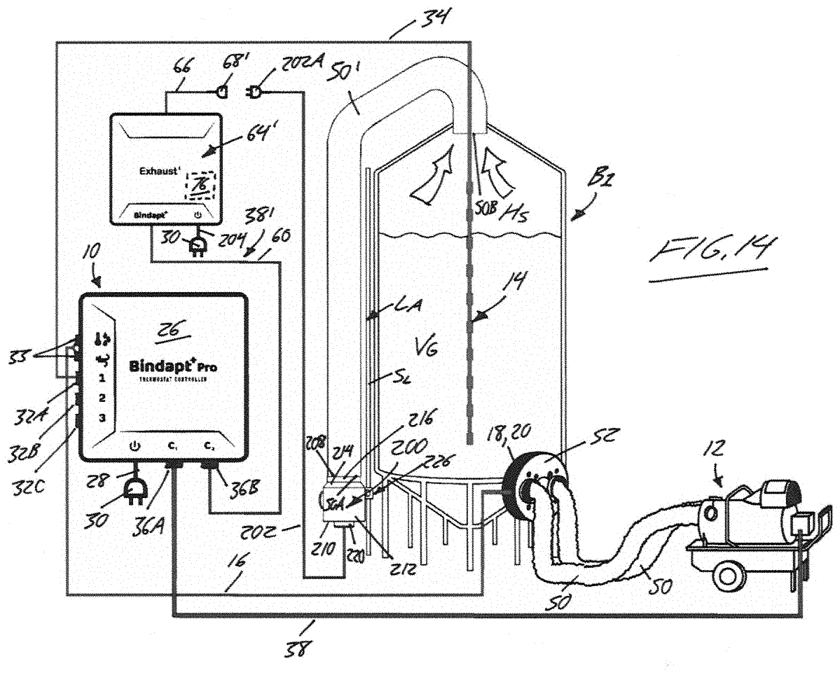

FIG. 14 illustrates a single-bin storage setup making use of shared system components from the various storage scenarios illustrated in FIGS. 1 through 5, but with the extra addition of a novel headspace exhaust kit composed of a fan unit 200, a flexible exhaust duct 50′, and an exhaust fan control cable 38′. In the FIG. 14 scenario, both output terminals 36A, 36B of the main control unit 10 are put to use in a manner controlling conditions in the same bin B₁ as one another via controlled operation of a heater/fan combination, as previously described for FIGS. 4 and 5, but instead of an existing aeration fan of the storage bin, the controlled heater/fan combination in the FIG. 14 scenario uses the separate exhaust fan unit 200 installed in novel fashion on the exterior of the storage bin B₁ for the purpose of evacuating humid air from the headspace H_{S} of the bin. In the FIG. 14 example, the system includes the main control unit 10, one portable construction heater 12, one sensor stick 14 penetrating the columnar volume of stored grain V_{G} inside the bin B₁, and one plenum sensor cable 16, all of which are installed in the same manner described for the first bin B₁ of FIG. 1, Output terminal 36A of the main control unit 10 is occupied in engaged fashion by a control cable 38 running to the portable construction heater 12 for controlled operation thereof, as described earlier. Output terminal 36B is instead occupied in engaged fashion by the exhaust fan control cable 38′, which links the main control unit 10 to the novel exhaust fan unit 200 for controlled operation thereof.

Just like the other control cables 38 described earlier, the exhaust fan control cable 38′ features a control box 64′ with a proximal cable section 60 running therefrom for connection to either output terminal 36A, 36B of the main control unit 10. Once again, the control box 64 contains a relay 76 therein whose primary side is wired to the proximal cable section 60 for connection to the output terminal 36B of the main control unit 10. Accordingly, a low voltage command signal sent from the output terminal 36B of the main control unit 10 is used to close the secondary side of the relay when the processor-executed dryer routines call for exhausting of the bin's headspace H_{S}, for example based at least partly on the headspace humidity level detected by an exposed sensor node of the sensor stick 14 that is left in an unsubmerged position outside the stored volume of grain V_{G} in the air-filled headspace H_{S}, as described earlier. As mentioned previously, a discrete headspace sensor unit separate from the sensor stick 14 may alternatively be employed for the headspace humidity measurements. When the detected headspace humidity exceeds a threshold level, which may be user-configurable via the user-interface, the main control unit 10 commands activation of the exhaust fan unit 200.

A distal cable section 66 of the exhaust fan control cable 38′ is once again wired to the secondary side of the control box relay 76, but instead of terminating in a male plug 68 like the other control cables 38, the distal cable section 66 of the exhaust fan control cable 38′ terminates in a female socket connector 68′ into which a power cord 202 of the exhaust fan unit 200 can be plugged for electrical connection to the secondary side of the relay 76. Unlike the control boxes of the other control cables 38, the control box 64′ of the exhaust fan control cable 38′ also features a mains power cord 204 that is wired to the secondary side of the relay 76, and terminates in a male power plug 30 connectable to a mains power source via a conventional mains power outlet. Accordingly, closure of the secondary side of the relay 76 will connect the exhaust fan unit 200 to a mains power source, thereby activating the exhaust fan.

The female socket connector 68′ thus serves as a controlled power socket into which a male plug 202A of the power cord 202 of the exhaust fan unit 200 is selectively pluggable into electrical connection to the control box 64′ to enable automated control of the exhaust fan unit 200 by the master control unit 10. Alternatively, the power cord 202 of the exhaust fan unit 200 can be plugged into a mains power outlet, thus bypassing the control box 64′, in which case the exhaust fan is directly powered and thus operated independently of the main control unit 10. From this, it will be appreciated that the exhaust fan unit 200 and flexible exhaust duct 50′ can optionally be used independently of the other system components described herein for use on any grain storage bin. While the illustrated embodiment uses a dedicated control box 64′ to house the relay separately of the exhaust fan unit, this need not necessarily be the case in other embodiments.

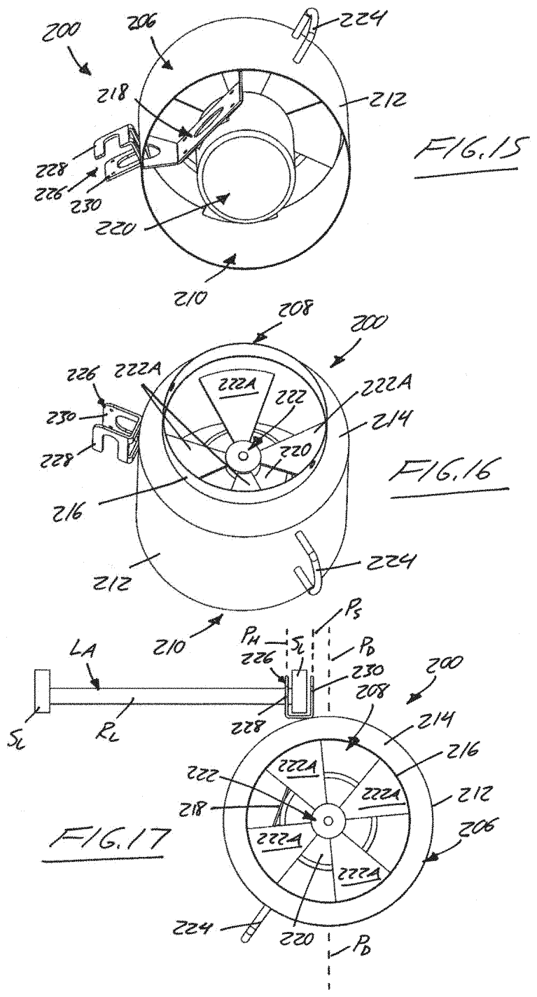

Turing to FIGS. 15 to 17, the exhaust fan unit 200 features an outer shroud 206 having an upper inlet end 208 and an opposing lower outlet end 210, each of which delimits a circular opening. In the illustrated embodiment, the circular opening of the inlet end 208 is of lesser diameter than that of the wider outlet end 210. Starting from the lower outlet end 210 and moving upwardly therefrom, the shroud 206 is composed of a cylindrical wall 212 spanning a majority of the shroud's axial length, a frustoconically tapered wall 214 spanning a shorter axial distance from a top end of the cylindrical wall 212, and finally a cylindrical connection collar 216 spanning a short axial distance from the narrow top end of the tapered wall 214 to the upper inlet end 208 of the shroud. A support bracket 218 affixed to an interior of the cylindrical wall 212 supports a fan motor 220 in a position concentric relation to the surrounding cylindrical wall 212 of the shroud 206. A fan rotor 222 of rotatably supported and driven relation to the fan motor 220 resides in overhead relation thereto inside an upper region of the shroud's cylindrical wall 212. When rotatably driven by the fan motor 220, the blades 222A of the fan rotor 222 draw air downwardly into the shroud through the upper inlet end 208 thereof, and force the drawn air downwardly through the opposing lower outlet end 210 of the shroud.

On an exterior of the shroud 206, the exhaust fan unit 200 features a carrying handle 224 and a mounting bracket 226, both of which are affixed to an exterior of the shroud's cylindrical wall 212 at respective positions spaced discretely around the circumference thereof, for example at more than 90-degrees, but less than 180-degrees from one another, and also less than 150-degrees from one another in the illustrated example. The illustrated mounting bracket 226 features hanger portion of inverted U-shape (i.e. downwardly-opening U-shape) in a plane P_{H} parallel to a central longitudinal axis shared by the shroud 206, fan motor 220 and fan rotor 22, and a stabilizer portion 230 residing in a plane P_{S} parallel to that of the hanger portion 228, but spaced a short distance therefrom. Both the hanger and stabilizer portions 228, 230 project outwardly away from the shroud's cylindrical wall 112, to which they are affixed.

The mounting bracket 226 is engageable with an exterior access ladder L_{A} of the storage bin B₁ in order to support the fan unit 210 externally upon the storage bin B₁. The open bottom end of the hanger portion's inverted U-shape is slipped overtop of a selected rung R_{L} of the access ladder L_{A}, thereby engaging the hanger portion 228 in embraced relation over the ladder rung R_{L}, particularly in a position with the stabilizer portion 230 residing adjacent an outer side of one of the ladder's stiles SL. The exhaust fan unit 200 thus hangs from the ladder rung R_{L} in an axially upright orientation resting against the front of the ladder stile SL, whose position between the two portions 228, 230 of the mounting bracket 226 blocks side to side displacement or rotation of the hanging fan unit 200. In the illustrated example, the entire mounting bracket 226 is offset to one side of a diametric plane Po of the shroud 206 that lies parallel to the planes P_{H}, P_{S} of the bracket's two parallel portions 228, 230, of which the stabilizer portion 230 is nearer to this diametric plane Po than the hanger portion 228. As a result, a lesser fraction of the fan unit's overall width 200 resides in front of the ladder L_{A} than if the mounting bracket 226 were centered on the diametric plane P_{D}. As seen in FIG. 17, this offsetting of the mounting bracket to one side of the shroud 206 makes the fan unit 200 less obstructive to the ladder L_{A}, thereby ensuring ongoing access thereto for ongoing use thereof regardless of the exhaust fan's installed state.

As shown in FIG. 14, the exhaust fan unit 200 is installed in supported fashion on the access ladder L_{A} at a relatively low elevation nearer to ground level than to the roof of the storage bin B₁, for example at a user-selected lower rung somewhere within a 6-foot range of ground level, whereby the fan unit can be installed from ground level without needing to carry the heavy fan unit 200 up the ladder to the bin roof or other elevated location. The flexible exhaust duct 50′ is preferably the same type of commercially available portable heater ducting 50 that is used between the portable heater 12 and the aeration fan 20. The flexible exhaust duct 50′ is installed in a working position coupled to the inlet end 208 of the exhaust fan unit 200 and running up the exterior side of the storage bin B1 beside the access ladder L_{A} thereof. The connection collar 216 at the inlet end 208 of the exhaust fan unit 200 is sized for mating fit with an outlet end 50A of the flexible exhaust duct 50′. At the perimeter of the storage bin roof, the installed exhaust duct 50′ turns inwardly toward the center of the bin roof, where an opposing inlet end 50B of the exhaust duct 50′ is hung downwardly into the headspace H_{S} of the storage bin B₁ through a central bin-fill opening in the roof of the storage bin.

While the illustrated example in FIG. 14 shows the inlet end 50B of the exhaust duct 50′ as being inserted into the bin's headspace H_{S} through the bin-fill opening, the bin-fill opening may alternatively be equipped with a modified cover having a duct-connection collar on the topside thereof that surrounds a through-hole in the cover, and by which the inlet end 50B of the exhaust duct 50′ can be coupled in mating fashion, just as the opposing outlet end 50A of the exhaust duct 50′ is coupled to the connection collar 216 at the inlet end 208 of the fan unit 200. In an open position, the cover and the duct's attached inlet end 50B would be withdrawn from the bin-fill opening, while a closed position of the cover would place the duct's inlet end 50B in fluid communication with the bin's headspace H_{S} through an opening in the otherwise closed cover.

When the fan motor 220 of the installed exhaust fan unit 200 is activated, the driven rotation of the fan rotor 222 draws moisture-rich air out from the headspace H_{S} of the bin B₁ through the duct-equipped bin-fill opening, and pulls this extracted headspace air externally down the side of the bin through the flexible exhaust duct 50′ to the fan unit 200, where this extracted headspace air is finally exhausted to the surrounding ambient environment through the lower outlet end 210 of the fan unit 200.

The installation of the headspace exhaust kit is relatively straightforward and safe, compared to installation of a rooftop exhaust fan. The fan unit 200 is installed externally of the storage bin B₁ from ground level, for example by the simple ladder-hung support thereof in the illustrated embodiment, though hung or otherwise secured mounting of the fan unit to the ladder, support legs or other exterior structure of the bin may alternatively be employed. With the flexible and axially collapsible/expandeable exhaust duct 50′ held in an axially collapsed state of compacted size, an installer can climb the access ladder L_{A} to the roof of the bin B₁, and install the inlet end 50B of the exhaust duct 50′ in an inserted or otherwise secured working relation to the bin-fill opening, or any other available and suitably-sized rooftop opening of the bin, thereby placing the duct's inlet end 50B in fluid communication with the bin's headspace H_{S}.

With this inlet end 50B of the exhaust duct 50′ sufficiently secured in place, the opposing end of the flexible exhaust duct 50′ can be simply thrown off the bin roof so that the flexible duct 50′ hangs in suspended relation alongside the exterior wall of the bin B₁. The bottom outlet end 50B of the now-hanging exhaust duct 50′ is then coupled to the connection collar 216 at the upper inlet end 208 of the exhaust fan unit 200, once installed on the ladder, or at another suitable mounting location outside the bin. The power cord 202 running from the fan motor 220 of the exhaust fan unit 200 is plugged into the exhaust fan control box 64′, which in turn is plugged into both a mains power outlet and the main control box 10, thereby completing the installation of the headspace exhaust kit. While the illustrated example shows the exhaust duct 50′ and the installed sensor stick 14 sharing the same rooftop opening (e.g. a centrally located bin-fill opening through grain is typically auger-loaded into the bin), it will be appreciated that they may alternatively be installed at different rooftop openings from one another.

Though the detailed embodiments described above are framed in the context of grain storage, it will be appreciated that the systems, devices and methods described herein may likewise be applied to other agricultural assets, and though the preferred embodiment of the overall system is particularly well suited to adaptation of storage bins to perform automated grain drying therein, it will be appreciated that devices and method described herein may likewise be used to take grain temperature and/or moisture measurements in a variety of settings and contexts, whether specifically used for the purpose of automating a heated grain drying operation, or to other ends.

Since various modifications can be made in my invention as herein above described, and many apparently widely different embodiments of same made, it is intended that all matter contained in the accompanying specification shall be interpreted as illustrative only and not in a limiting sense.

1. A portable system for monitoring and conditioning of agricultural assets held in aerated storage bins equipped with aeration fans, said system comprising:
one or more sensor sticks each comprising:
an elongated shaft that is composed of one or more shxposaft sections of substantially rigid tubular shape, has a hollow interior running axially through said one or more shaft sections, and has a piercing end that is penetrable into a stored volume of an agricultural asset held in an upright storage bin; and
a respective sensor cable received or receivable in said hollow interior of the elongated shaft in a position running axially therethrough, said elongated sensor cable having a plurality of sensor nodes thereon at spaced intervals therealong to measure one or more conditions outside said sensor stick at respective localized areas therealong, thus being operable to measure said one or more conditions at localized regions within said stored volume of said agricultural asset; and
a controller that:
comprises one or more input terminals from which incoming signals are receivable from at least the sensor nodes of the one or more sensor sticks to receive measurement signals therefrom that are indicative of said one or more conditions at said localized regions within said columnar volume of said agricultural asset;
comprises one or more output terminals from which control signals are transmittable from said controller to control at least operation of a portable heater that is operable to feed heated air into an aeration fan of said storage bin; and
is configured to adjust output from said one or more output terminals based at least partly on said incoming signals, and to thereby selectively control heated aeration of said agricultural asset in said storage bin.

2. The system of claim 1 wherein said one or more shaft sections comprise a plurality of shaft sections configured for selective end-to-end connection to one another, the sensor cable comprises a respective plurality of cable sections provided in equal quantity to said plurality of shaft sections, and said cable sections comprise matable plugs and sockets at ends thereof for interconnection of said cable sections, whereby the sensor stick is assemblable to a user-selected length by choosing how many of the shaft sections and respective cable sections to assemble together to achieve said user-selected length.

3. The system of claim 1 wherein said one or more shaft sections comprise a plurality of shaft sections configured for selective end-to-end connection to one another via non-threaded quick-release couplers at matable ends of said plurality of shaft sections.

4. (canceled)

5. The system of claim 1 wherein said one or more shaft sections include a distal shaft section that defines said piercing end of the elongated shaft and comprises helical flighting that spirals around an exterior of distal shaft section.

6. The system of claim 2 wherein said plurality of shaft sections include a distal shaft section that defines said piercing end of the elongated shaft, and one or more shorter shaft sections that are each shorter in length than said distal shaft section, and are selectively attachable to said distal shaft section at a proximal end thereof opposite the piercing end.

7. The system of claim 6 wherein the respective cable sections include a distal cable section for said distal shaft section, and for each of the one or more shorter shaft sections, a respective shorter cable section that is shorter that the distal cable section.

8. The system of claim 7 wherein the distal cable section has multiple sensor nodes thereon, and each shorter cable section has a lesser quantity of sensor nodes thereon than said distal cable section.

9. The system of claim 1 wherein the sensor stick further comprises a handle selectively attachable to the elongated shaft at a proximal end thereof situated oppositely of the piercing end.

10-12. (canceled)

13. The system of claim 1 wherein the output terminals of the controller comprise two output terminals by which respective control signals are transmittable to both said portable heater and said aeration fan, or to two respective heaters for heating two different storage bins.

14. The system of claim 13 wherein the input terminals of the controller comprise at least two input terminals by which incoming signals are receivable to receive measurement data from said two different storage bins.

15. The system of claim 1 wherein the output terminals of the controller are connected or selectively connectable to a control cable with a male plug of a type compatible with a female thermostat connection socket on the portable heater.

16. The system of claim 1 wherein said plurality of sensor nodes includes a proximal sensor node that resides furthest from the piercing end of the sensor stick and is operable to measure one or more air conditions in an air-filled headspace of the upright storage bin above the stored volume of the agricultural asset.

17. The system of claim 16 wherein said controller is configured to, at least during a drying cycle, monitor moisture levels in said air-filled headspace based on the measurement signals from the proximal sensor node.

18. (canceled)

19. The system of claim 1 further comprising one or more plenum sensor cables operable to measure one or more plenum conditions inside a plenum space of the upright storage bin, and wherein the controller is configured such that at least one of the input terminals is a multi-purpose input terminal capable of interchangeably receiving either a plenum sensor cable or the sensor cable of the sensor stick.

20. The system of claim 19 wherein said one or more plenum sensor cables comprise a primary plenum sensor cable that is operable to measure a plurality of plenum conditions and is incompatible with the multi-purpose input terminal, and a secondary plenum sensor cable that is operable to measure a lesser quantity of plenum conditions than said primary plenum sensor cable and is compatible with said multi-purpose input terminal.

21-26. (canceled)

27. The system of claim 1 wherein each sensor node comprises:
a sensor housing that is received in the hollow interior of the elongated shaft and has an outer diameter of equal or similar measure to an internal diameter of the elongated shaft to maintain said sensor in substantially coaxial relationship with said elongated shaft;
a sensing unit supported by the sensor housing; and
within an internal cavity of the sensor housing, a wired connection between said sensing unit and at least one communication cable by which signals are communicable between the controller and said sensing unit;
wherein a sensing portion of said sensing unit resides outside the internal cavity of the sensor housing to fluidly communicate with the hollow interior of the elongated shaft, and also with a respective one of the localized areas outside the sensor stick via one or more nearby openings provided in the elongated shaft near said sensing portion of the sensing unit.

28-31. (canceled)

32. A sensor stick for measuring conditions of agricultural assets held in upright storage bins, said sensor stick comprising:
an elongated shaft that is composed of one or more shaft sections of substantially rigid tubular shape, has a hollow interior running axially through said one or more shaft sections, and has a piercing end that is penetrable into a stored volume of an agricultural asset held in an upright storage bin; and
a respective sensor cable received or receivable in said hollow interior of the elongated shaft in a position running axially therethrough, said elongated sensor cable having a plurality of sensor nodes thereon at spaced intervals therealong to measure one or more conditions outside said sensor stick at respective localized areas therealong, thus being operable to measure said one or more conditions at localized regions within said columnar volume of said agricultural asset;
wherein the sensor stick is further characterized by at least one of the following features:
(a) said one or more shaft sections comprise a plurality of shaft sections that are configured for selective end-to-end connection to one another, and are further characterized by:
(i) accompaniment by a respective plurality of cable sections that are assemblable to form the sensor cable and are provided in equal quantity to said plurality of shaft sections, said cable sections comprising matable plugs and sockets at ends thereof for interconnection of said cable sections, whereby the sensor stick is assemblable to a user-selected length by choosing how many of the shaft sections and respective cable sections to assemble together to achieve said user-selected length; and/or
(ii) inclusion of non-threaded quick-release couplers at matable ends of said plurality of shaft sections for selective end-to-end connection of said plurality of shaft sections to one another in quick non-threaded fashion;
(b) said one or more shaft sections include a distal shaft section that defines said piercing end of the elongated shaft, and said distal shaft section is further characterized by:
(i) inclusion of helical flighting on said distal shaft section that spirals around an exterior thereof; and/or
(ii) accompaniment of said distal section by one or more shorter shaft sections that are selectively attachable to said distal shaft section at a proximal end thereof opposite the piercing end, and that are each shorter in length than said distal shaft section;
(c) inclusion of a removable handle that is selectively attachable to the elongated shaft at a proximal end thereof situated oppositely of the piercing end to provide one or more radially elongated handle grips by which to drive manual rotation of the sensor stick; and/or
(d) inclusion of a tool-engageable drive feature attached or attachable at the proximal end of the sensor stick to enable tool-driven rotation of the sensor stick.

33-38. (canceled)

39. A method for monitoring and conditioning of agricultural assets, said method comprising:
having a plurality of submerged sensor nodes residing at submerged locations in a stored volume of an agricultural asset;
performing a drying cycle, including:
(a) forcing heated air flow through said stored volume of said agricultural asset in a predetermined direction therethrough;
while forcing said heated air flow through said stored volume of grain:
(b) monitoring conditions within said stored volume of grain using said submerged sensor nodes; and
(c) also monitoring air humidity outside said stored volume of said agricultural asset at a location through which said heated air flow is exhausted from said stored volume of said agricultural asset.

40-46. (canceled)

47. The system of claim 1 further comprising a headspace exhaust kit comprising an exhaust fan unit configured for supported installation in a working position nearer to ground level than to a roof level of the upright storage bin, and a flexible exhaust duct having one end connected, or configured for connection, to an inlet of the exhaust fan unit, and an opposing end placeable into fluid communication with a headspace of the upright storage bin via an elevated opening in the upright storage bin, a communication link connected or connectable between the controller and the exhaust fan unit and through which the controller is operable to selectively activate and deactivate the exhaust fan unit to selectively draw air from the headspace of the upright storage bin.

48-51. (canceled)

52. A headspace exhaust system for use in conditioning of an agricultural asset stored within an upright storage bin, said kit comprising:
an exhaust fan unit supported or configured for supported installation in a working position nearer to ground level than to a roof level of the upright storage bin; and
a flexible exhaust duct having one end connected, or configured for connection, to an inlet of the fan unit, and an opposing end placeable into fluid communication with a headspace of the upright storage bin via an elevated opening in the upright storage bin.

53-58. (canceled)
